(19) United States
(12) Patent Application Publication
(10) Pub. No.: US 2010/0282846 A1
(43) Pub. Date: Nov. 11, 2010

(54) MULTI-POCKET PAPER MONEY CALCULATING APPARATUS HAVING AN PAPER MONEY DISCRIMINATING FUNCTION AND AN AUTO BINDING FUNCTION AND AN OPERATION CONTROL METHOD THEREOF

(76) Inventors: Hyung-Hee Won, Seoul (KR); Ho-Gil Son, Seoul (KR)

Correspondence Address: IP & T Law Firm PLC, 7700 Little River Turnpike, Suite 207, Annandale, VA, 22003, US

(21) Appl. No.: 12/811,024

(22) PCT Filed: Dec. 26, 2008
(86) PCT No.: PCT/KR08/07719

§ 371 Date: Jun. 28, 2010

(30) Foreign Application Priority Data
Dec. 28, 2007 (KR) 10-2007-0140316
Dec. 26, 2008 (KR) 10-2008-0134508

(51) Int. Cl. G06F 7/08; G07D 3/00

(52) U.S. Cl. 235/425; 700/224

(57) ABSTRACT

Disclosed is a multi-pocket paper money counting apparatus having functions capable of easily discriminating different denomination notes, and automatically performing sequential steps of counting paper money and binding a wad of paper money to thereby obtain a rapid business processing time by eliminating a need of using an additional binding operation and improve functionality thereof. The multi-pocket paper money counting apparatus includes: a counting device for counting paper money; a transporting guide unit disposed inside of the counting device; a paper money transporting unit disposed on a transporting path for transporting paper money; a sensor unit for defecting paper money; a path changing device disposed on the transporting path for allowing paper money to be selectively transported into a first path or a second path; a central control device for controlling the associated components; and multi pockets each formed on outside of the counting device.

### TECHNICAL FIELD

The present invention relates to a multi-pocket paper money counting apparatus having a paper money discriminating function and an auto binding function, and an operation control method thereof; and more particularly, to a multi-pocket paper money counting apparatus and an operation control method thereof having a paper money discriminating function capable of easily discriminating denomination notes (different denomination notes and counterfeit notes and the like) except for paper money to be counted, as well as an auto binding-function capable of automatically performing sequential steps of counting predetermined amounts of paper money and binding the counted paper money to thereby obtain a rapid business processing time by eliminating a need of using an additional binding apparatus or a binding operation and improve functionality of the paper money counting apparatus.

### BACKGROUND ART

Generally, a paper money automatic counting apparatus for rapidly and accurately counting amounts of money is used in business places dealing with large amounts of money, for instance, financial institutions.

The paper money counting apparatus for counting amounts of money in paper types such as paper money and cheques starts to operate automatically when a user puts predetermined amounts of paper money on a receiving unit. That is, the paper money counting apparatus counts the predetermined amounts of paper money put on the receiving unit. Then, the paper money counting apparatus discharges the counted paper money to a designated outer part and displays the counted amount on a display unit.

When it is necessary to separate wads of the counted paper money into each predetermined amount and to easily carry the wads of paper money, a user additionally employs a paper money binding apparatus to bind the counted wad of paper money.

However, the conventional paper money counting apparatus has a mere function of counting a desired amount of paper money, and thus, the above mentioned paper money binding apparatus is additionally used to bind the desired amount of the counted paper money. For this reason, a user has to manually perform the counting operation and the binding operation since these two operations cannot be automatically performed. As a result of this manual operation, there are disadvantages of inconvenience and delayed business processing time.

In addition, most of the conventional paper money counting apparatus have a mere function of counting a paper money, and thus, it is required to a improved paper money counting apparatus capable of automatically performing sequential steps of counting predetermined amounts of paper money, discriminating different denomination notes, counterfeit notes and front-rear side of paper money (namely, sort function), and binding the counted paper money.

### DISCLOSURE OF THE INVENTION

Therefore, the present invention has been made in view of the above-mentioned problems, the present invention provide a multi-pocket paper money counting apparatus having an auto binding-function and an operation control method thereof, that allows an operation of counting a predetermined amount of paper money, operation of discriminating paper money and an operation of binding the predetermined amount of the counted paper money to be automatically performed, thereby providing convenience to a user by eliminating conventionally performed manual counting and binding operations, shortening a business processing time, and improving functionality and usability of the paper money counting apparatus.

In addition, the present invention provide a multi-pocket paper money counting apparatus having an auto binding-function, that includes components for discriminating different denomination notes and counterfeit notes in a small number of parts, thereby providing cost down of manufacture, simplicity of process and compact size.

In accordance with one aspect of the present invention, there is provided a multi-pocket paper money counting apparatus, comprising: a counting device configured to count predetermined amounts of paper money; a transportation guide unit configured to be disposed inside of the counting device for forming a transporting path which includes at least a first path through which paper money to be counted is transported and a second path through which other paper money except for paper money to be counted is transported; a paper money transporting unit configured to be disposed on the transporting path for transporting paper money; a sensor unit configured to defect paper money in the middle of transportation; a path changing device configured to be disposed on the transporting path for allowing paper money to be selectively transported into the first path or the second path; a central control device configured to control the associated components; and multi pockets each configured to be formed on outside of the counting device for displacing paper money discharged from the counting device.

The path changing device may includes: a rotary shaft; a driving unit configured to drive the rotary shaft; and a plurality of guide members configured to be integrally formed on the rotary shaft along the longitudinal direction of the rotary shaft in order to guide paper money to the first path or the second path.

The guide members may configured to an approximately triangle shape of which a lower surface forms a first guide surface for guiding paper money to the first path when the guide members allows paper money to be transported to the first path, and a side surface adjacent to lower surface forms a second guide surface for guiding other paper money to the second path when the guide members allows other paper money to be transported to the second path.

In accordance with another aspect of the present invention, there is provided a multi-pocket paper money counting apparatus, comprising: a counting device configured to count predetermined amount of paper money; a selection discharging device configured to discriminate other paper money except for paper money to be counted, and to discharge the discriminated paper money outside from the counting device; a central control device configured to control the associated components; and

multi pockets each configured to be formed on outside of the counting device for displacing at least the counted paper money and other paper money both which are discharged from the counting device.

The selection discharging device may includes: a sensor unit configured to be disposed at upstream side of a paper money transportation path in order to defect paper money in the middle of transportation; a path changing unit configured to be disposed at downstream side of the paper money transportation path in order to allowing paper money to be selectively transported into a first path for paper money to be counted or a second path for different denomination notes except for the paper money to be counted; a driving unit configured to drive the path changing unit; a transportation guide unit configured to form the second path for different denomination notes transported by the path changing unit; a transporting unit configured to be disposed at the second path for different denomination notes for transporting the different denomination notes; and a stacker configured to be formed on one of the multi pockets in order to place the different denomination notes which are guided by the transportation guide unit and are discharged outside of the counting device.

The path changing unit may includes: a rotary shaft; a driving unit configured to drive the rotary shaft; and a plurality of guide members configured to be integrally formed on the rotary shaft along the longitudinal direction of the rotary shaft in order to guide paper money to the first path or the second path.

The guide members may formed into an approximately triangle shape of which a lower surface forms a first guide surface for guiding paper money to the first path when the guide members allows paper money to be transported to the first path, and a side surface adjacent to lower surface forms a second guide surface for guiding different denomination notes to the second path when the guide members allows different denomination notes to be transported to the second path.

The sensor unit may be configured to a contact image sensor (CIS), a infrared sensor (IR sensor), an ultraviolet sensor (UV sensor), a magnetic sensor (MG sensor) and a color recognition sensor, in single or in combination.

The counting apparatus may further comprises an arrangement device configured to arrange a wad of the discharged paper money. The arrangement device may includes: an up-down arrangement device configured to be mounted on a side of the counting device in order to arrange the wad of paper money up and down; and a front-rear arrangement device configured to be mounted inside of the counting device in a place where the front-rear arrangement device faces to a rear side of the wad of paper money in order to arrange the wad of paper money backward and forward.

The counting apparatus may further comprises a transportation device configured to transport the wad of the paper money to a predetermined place, wherein the wad of paper money is counted by the counting device and is discharged through the first path; and a binding device configured to be integrally formed in one side of the counting device in order to bind the wad of paper money transported by the transportation device. Herein, the transporting device serves in a role of a left-right arrangement device for arranging a lateral side of the wad of paper money.

Also, in accordance with still another aspect of the present invention, there is provided an operation control method for a multi-pocket paper money counting apparatus, comprising steps: placing paper money to be counted; defecting paper money to be counted and other paper money to be not counted among paper money in the middle of transportation; and guiding paper money to be counted into a first path and other paper money into a second path based on the defected result, and then discharging paper money and other paper money from the first path and the second path, respectively.

The guide step may includes allowing the one of the first path and the second path to be changed and selected by a path changing unit based on the defection result, wherein the first path and the second path are disposed on a downstream side of a transportation path through which paper money is transported.

The operation control method for a multi-pocket paper money counting apparatus may further comprises a step of arranging a wad of paper money which are discharged from the first path in use of a arrangement device, before and after the wad of paper money is transported in a predetermined place or during the transportation, and may further comprises steps: transporting the wad of the discharged paper money; and binding the wad of the transported paper money.

### ADVANTAGEOUS EFFECTS

According to the present invention, the multi-pocket paper money counting apparatus having a paper money discriminating function and an auto binding function is capable of automatically performing sequential steps of counting, discriminating and binding paper money to thereby provides improvement of operation efficiency, functionality and usability.

Also, the multi-pocket paper money counting apparatus includes the associated components for performing the above-mentioned various functions in a small number of parts, thereby reducing the cost of manufacture, simplifying the process of manufacture and providing compact structure.

### BRIEF DESCRIPTION OF THE DRAWINGS

Other objects and aspects of the invention will become better understood with respect to the following description of the preferred embodiments given in conjunction with the accompanying drawings, in which:

FIG. 1 is a front perspective view showing a multi-pocket paper money counting apparatus provided with a paper money discriminating-function and an auto binding-function in accordance with the present invention;

FIG. 2 is a rear perspective view partially showing the multi-pocket paper money counting apparatus provided with the auto binding-function in accordance with the present invention;

FIG. 3 is an interior perspective view showing the multi-pocket paper money counting apparatus provided with the auto binding-function in accordance with the present invention;

FIG. 4 is a rear perspective view showing an internal structure of the multi-pocket paper money counting apparatus in accordance with the present invention;

FIG. 5 is a side cross-sectional view showing an internal structure the counting device configured in the multi-pocket paper money counting apparatus provided with the auto binding-function, when the apparatus is in a normal counting mode, in accordance with the present invention;

FIG. 6 is an enlarged view of “A” portion in FIG. 5;

FIG. 7 is a side view showing a path changing unit (selector) configured in a selection discharging device, in a case that the path changing unit is positioned in the normal counting mode, in accordance with the present invention;

FIG. 8 is a side cross-sectional view showing the internal structure the counting device configured in the multi-pocket paper money counting apparatus provided with the auto binding-function, when the apparatus is in a discriminating mode, in accordance with the present invention;

FIG. 9 is a side view showing the path changing unit (selector) configured in the selection discharging device, in a case that the path changing unit is positioned in the discriminating mode, in accordance with the present invention;

FIG. 10 is a perspective view showing a part of a transportation guide configured in the multi-pocket paper money counting apparatus, in which the transportation guide unit is integrally formed with a stacker, in accordance with the present invention.

FIG. 11 is a perspective view showing a transportation device configured in the multi-pocket paper money counting apparatus provided with the auto binding-function in accordance with the present invention;

FIG. 12 is a top view showing another type of a rotation plate configured in the transporting device of the multi-pocket paper money counting apparatus in accordance with the present invention;

FIG. 13 is a perspective view showing a binding device of the multi-pocket paper money counting apparatus provided with the auto binding-function in accordance with a preferred embodiment of the present invention;

FIG. 14 is a perspective view showing the configuration of the binding device except for a roll paper guide unit in the multi-pocket paper money counting apparatus in accordance with the preferred embodiment of the present invention;

FIG. 15 is a perspective view showing a binding device of the paper money counting apparatus provided with an auto binding-function in accordance with another preferred embodiment of the present invention;

FIG. 16 is a perspective view showing the configuration of the binding device except for a roll paper guide unit in the paper money counting apparatus in accordance with said another preferred embodiment of the present invention;

FIG. 17 is a perspective view showing a binding device of the paper money counting apparatus provided with an auto binding-function in accordance with still another preferred embodiment of the present invention;

FIG. 18 is a perspective view showing a up-clown arrangement device of the paper money counting apparatus provided with an auto binding-function in accordance with the present invention;

FIG. 19 is a perspective view showing a front-rear arrangement device of the paper money counting apparatus provided with an auto binding-function in accordance with the present invention;

FIG. 20 is a perspective view showing the path changing unit (selector) configured in the selection discharging device provided with the multi-pocket paper money counting apparatus in accordance with the present invention.

FIG. 21 is an exploded-perspective view showing a transportation guide unit for different denomination notes configured in the multi-pocket paper money counting apparatus in accordance with the present invention.

FIG. 22 is a perspective view showing a part of a transporting unit for different denomination notes configured in the multi-pocket paper money counting apparatus in accordance with the present invention.

FIG. 23 is a configuration diagram showing a central control device of the multi-pocket paper money counting apparatus in accordance with the present invention;

FIG. 24 is a flowchart for describing steps of an operation in the multi-pocket paper money counting apparatus in accordance with the present invention; and

FIGS. 24 and 25 are flowcharts for describing steps of an operation in the multi-pocket paper money counting apparatus in accordance with present invention.

### BEST MODE FOR CARRYING OUT THE INVENTION

The above object, features and advantages of the present invention will become apparent from the following description of the preferred embodiments with reference to the accompanying drawings. Hereinafter, a multi-pocket paper money counting apparatus having a paper money discriminating function and an auto binding function will be described in detail with reference to the accompanying drawings.

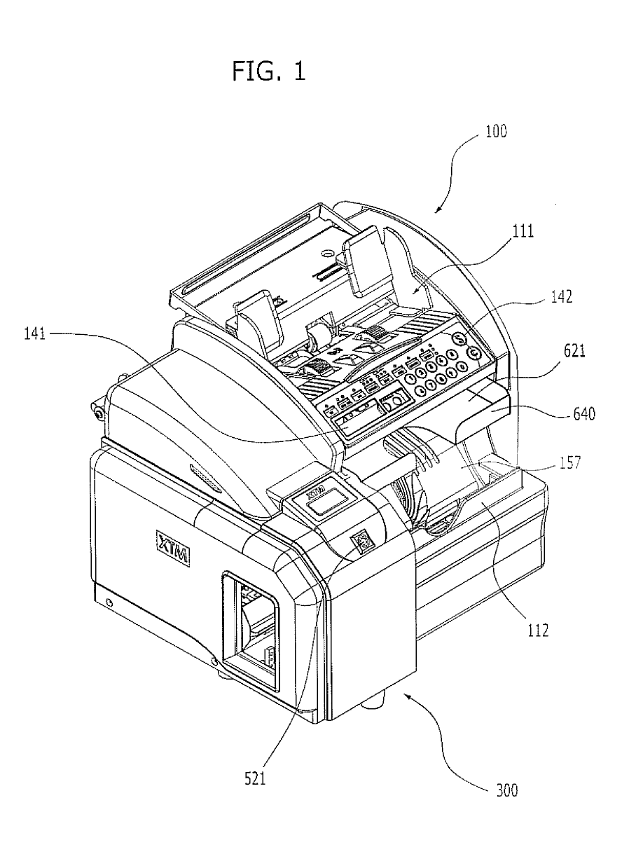

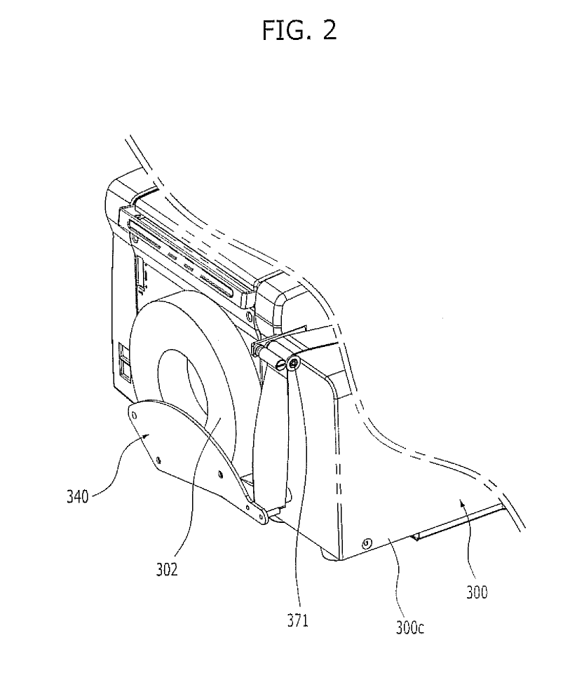

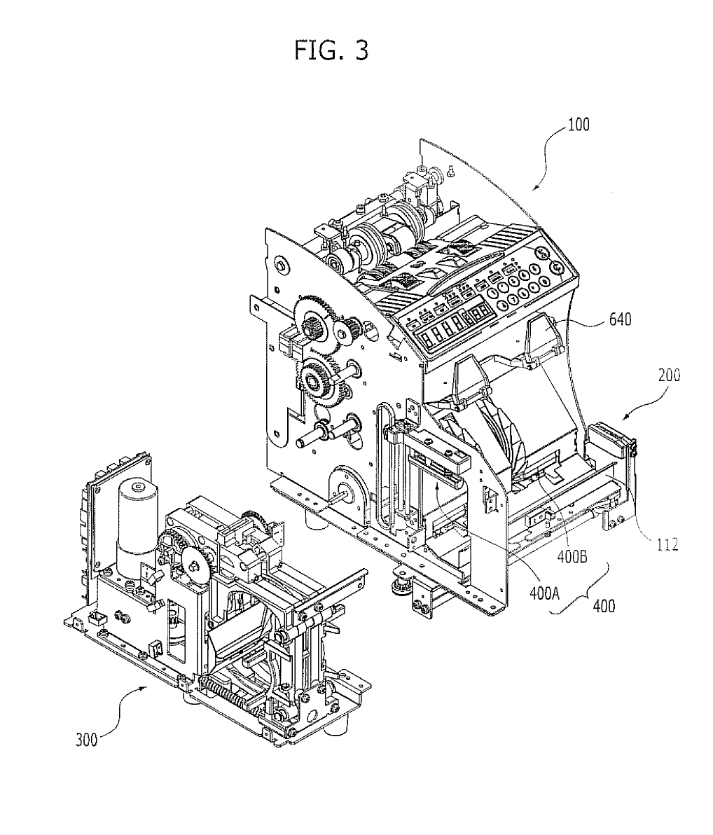

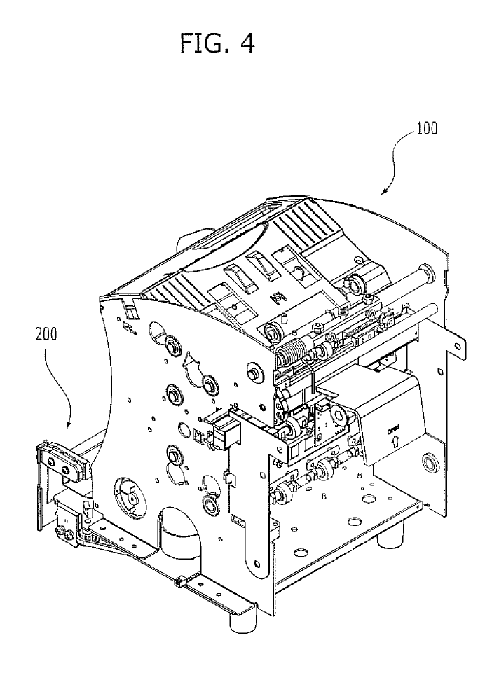

FIG. 1 is a front perspective view showing the multi-pocket paper money counting apparatus provided with the paper money discriminating function and the auto binding function in accordance with the present invention. FIG. 2 is a rear perspective view partially showing the multi-pocket paper money counting apparatus provided with the auto binding function. FIG. 3 is an interior perspective view showing the multi-pocket paper money counting apparatus provided with the auto binding function. FIG. 4 is a rear perspective view showing an internal structure of the multi-pocket paper money counting apparatus.

As shown in the drawings, the multi-pocket paper money counting apparatus provided with the auto binding function is configured as follows.

The multi-pocket paper money counting apparatus comprises: a counting device 100 for counting paper money and displaying the count result by an inputted command and for discharging the counted paper money outside; a transportation device 200 for transporting a wad of the discharged paper money from the counting device 100 to one designated place; a binding device 300 for binding the wad of the discharged paper money transported by the transporting device 200, the binding device 300 being integrated in one side of the counting device 100; a selection discharging device (not shown) for discriminating paper money expect for paper money to be counted (hereafter, referred as other paper money) and for discharging other paper money outside of the counting device 100; and a central control device 500 for controlling the associated components. Also, the multi-pocket paper money counting apparatus comprises multi pockets respectively disposed on outside of the counting device, in which the counted paper money is discharged and positioned on one of the multi pockets, and other paper money is discharged and positioned on another of the multi pockets.

In addition, the multi-pocket paper money counting apparatus may further comprises an arrangement device 400 for arranging the wad of paper money discharged from the counting device 100 and transported by the transporting device 200, or a discharging device for discharging the wad of paper money bound at the binding device 300.

More detailed description on configuration devices and components of the multi-pocket paper money counting apparatus provided with the auto binding function will be provided in the following.

(1) Counting Device 100

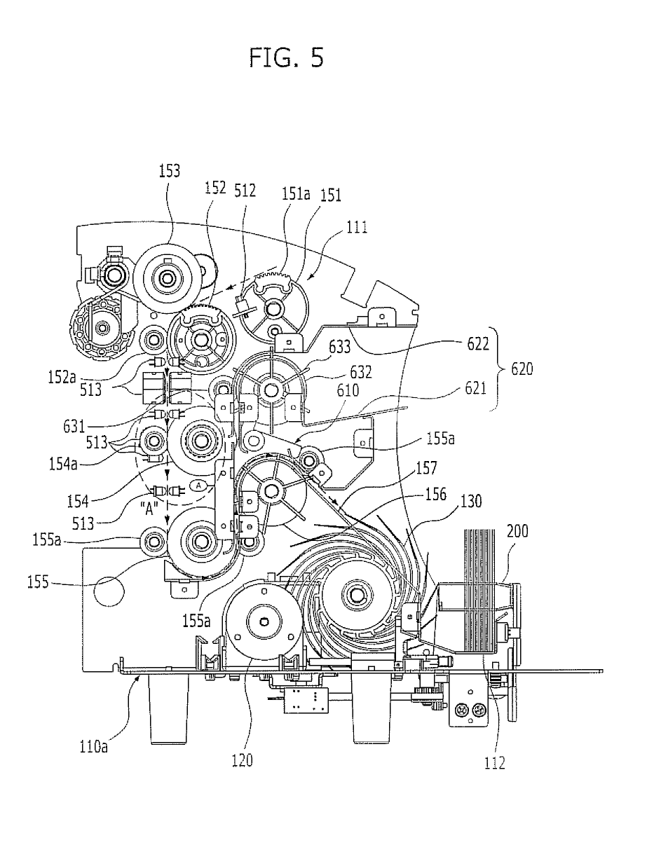

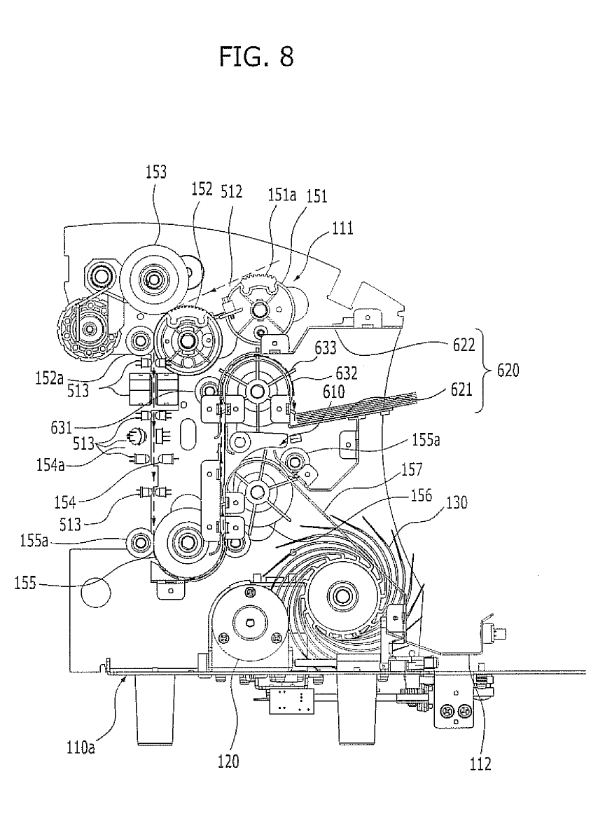

The counting device 100 will be described with reference to FIGS. 5 and 8. FIGS. 5 and 8 are side cross-sectional views respectively showing an internal structure the counting device configured in the multi-pocket paper money counting apparatus provided with the auto binding function in accordance with the present invention. As described below, FIG. 5 is the side cross-section view showing that the apparatus is in a normal counting mode, and FIG. 8 is the side cross-view showing that the apparatus is in a discriminating mode.

As shown in the drawing, the counting device 100 includes: a base frame 110a; a case 110 forming an outward shape of the counting device 100, and having a paper money receiving unit 111 at an upper portion of the case on which paper money to be counted are placed and a stacker 112 at a lower portion of the case on which the counted paper money is discharged and stacked; a main motor 120 mounted on the base frame 110a disposed on an bottom of the case 110; a paper money transporting unit driven by the main motor 120 and composed of a plurality of feeding rollers and idlers which are disposed at a transportation path into which paper money from the paper money receiving unit 111 enters; a discharge motor (not shown) mounted on one side of the main motor 120; a discharge wheel 130 rotating as the discharge motor 124 actuates and having a plurality of spiral discharge wings in an outer circumferential surface of the discharge wheel 130; a sensor unit disposed on the paper money receiving unit 111 and the transportation path for detecting the existence or absence of paper money and determines amounts of the paper money; a display 141 for expressing the count result by an input signal from the sensor unit and displaying a status of the paper money counting apparatus; a plurality of function keys 142 being configured in an exterior side of the case 110 for inputting various commands; and pocket parts each configured in an exterior side of the counting device 100 so that paper money discharged by the paper money transporting unit is positioned and other paper money discharged by the selection discharging device is positioned, respectively.

The paper money transporting unit includes a pick-up roller 151 disposed on the paper money receiving unit 111; a base roller 152 placed in one side of the pick-up roller 151; a reverse roller 153 contacting with the base roller 152 at its periphery; a first feeding roller 154 and a second feeding rollers 155 downwardly placed from the base roller 152, respectively; idlers 152a, 154a, 155a each contacting with the base roller 152, the first feeding roller 154 and the second feeding roller 155, respectively; a third feeding roller 156 placed between the discharge wheel 130 and the second feeding roller 155; and a transporting guide 157 for guiding paper money from the second feeding roller 155 to the third feeding roller 156 and for guiding paper money from the third feeding roller 156 to the discharge wheel 130. It is preferable that an end portion of the transporting guide 157 is extended and formed into a stacker 112. FIG. 10 shows a part of the transporting guide which is integrally formed with the stacker in accordance with an embodiment of the present.

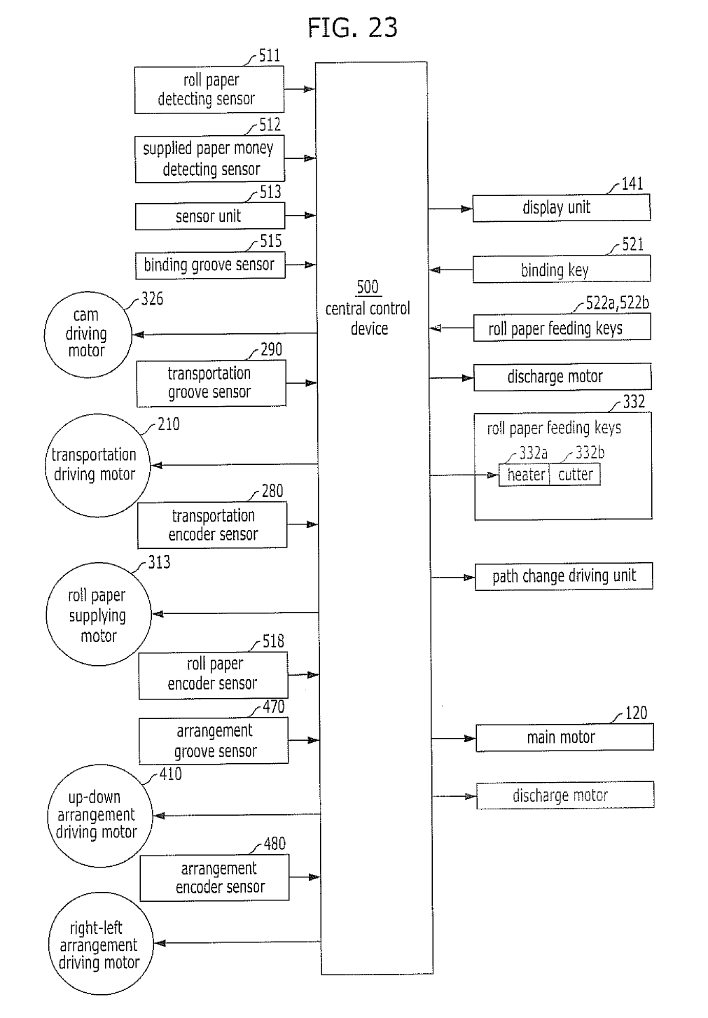

The sensor unit includes: a supplied paper money detection sensor 512 for detecting whether paper money is disposed on a designated place by being placed in one side of the paper money receiving unit 111 where paper money is disposed; a discharged paper money detection sensor 513 (refer to FIG. 23) for detecting the discharged paper money by being placed in one side where the stacker 112 faces inwardly; and a plurality of paper money detection sensors for detecting amounts of paper money being transported along the paper money transportation path by being placed in the paper money transportation path.

A rubber 151a for increasing a frictional force with surfaces of paper money is disposed in an outer circumferential portion of the pick-up roller 151. Each roller is connected each other and is driven through a use of a pulley and a belt or gears as a connection medium, and a detailed description thereof is omitted.

(2) Transporting Device 200

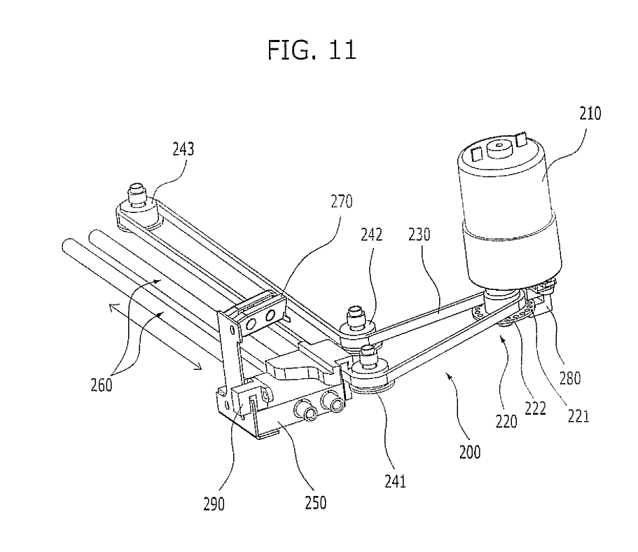

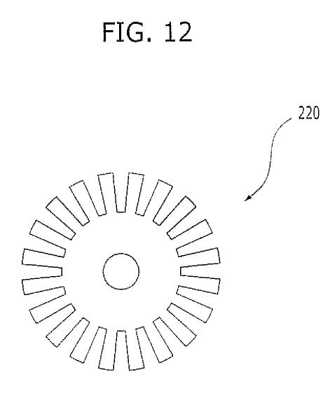

With reference to FIGS. 11 and 12, the transportation device 200 will be described in more detail. The transportation device 200 plays a role in transporting a wad of paper money counted and then discharged from the counting device 100 to the binding device 300. FIG. 11 is a perspective view showing the transportation device configured in the multi-pocket paper money counting apparatus provided with the auto binding function in accordance with the present invention, and FIG. 12 is a top view showing another type of a rotation plate configured in the transporting device of the multi-pocket paper money counting apparatus in accordance with the present invention.

The transportation device 200 includes: a transportation driving motor 210 formed in an interior side of the counting device 100 for generating a driving force; a driving pulley 220 rotating by the transportation driving motor 210 and having a rotation plate 222 with a plurality of detecting apertures opened with a predetermined distance along a rim of the rotation plate 222; a plurality of driven pulleys 241 to 243 rotating when receiving a driving force of the driving pulley 220 using a transportation driving belt 230 as a medium; a transportation base block 250 fixed in one portion of the transportation driving belt 230 and moving as the transportation driving belt 230 moves; at least one guide members 260 for guiding the movement of the transportation base block 250; a moving bar 270 extending from the transportation base block 250 and moving a wad of paper money stacked in the stacker 112 as the transportation base block 250 moves; and a control means for controlling operation of the transportation base block 250.

The transportation driving belt 230 forms a predetermined endless track that connects the driving pulley 220 with the plurality of driven pulleys 241 to 243.

Said at least one guide members 260 are preferably formed in a bar shape to allow said at least more than one guide members to pass through the transportation block 250, so that the transportation base block 250 can make a sliding movement along said at least more than one guide members 260. At this time, said at least one guide members 260 are preferably configured by a pair of guide bars for stably supporting and moving the transportation base block 250.

Also, a slide bearing (not shown) can be disposed inside of the transportation base block 250 through which said at least one guide members pass in order for the transportation base block 250 to make smooth left and right sliding movements on said at least one guide members 260.

The control means includes: a transportation encoder sensor 280 for controlling forward and reverse rotations of the transportation driving motor 210 to control left and right movement operations of the transportation base block 250; and an initializing sensor 290 being mounted on a portion of the transportation base block 250 and serving roles in checking an initial position (a starting point) of the transportation base block 250 and initializing the position of the transportation driving motor 210 when in error. Herein, the transportation encoder sensor 280 is a photo-sensor, and a detecting portion of the transportation encoder sensor 280 faces to the detecting apertures 221 of the rotation plate 222 of the driving pulley 220. Therefore, as the driving pulley 220 rotates, a detecting operation is carried out where the detecting apertures 221 are not formed and, in contrast, the detecting operation is not carried out where the detecting apertures 221 are formed. As a result of this selective detecting operation, the transportation encoder sensor 280 can detect the number of forward or reverse rotations made by the transportation driving motor 210.

Also, the driving pulley 220, the driven pulleys 241 to 243 and transportation driving belt 230 are media for driving the transportation base block 250 by receiving a driving force generated by the transportation driving motor 210. Also, it is well known that any configuration is allowable as long as the driving force provided from the transportation driving motor 210 can be delivered to the transportation base block 250.

Furthermore, as shown in FIG. 12, the rotation plate 222 can include: a circular body; and a plurality of protrusions protruded outwardly from an outer rim of the circular body with a predetermined distance. Hence, each predetermined distance between the protrusions serves as the detecting apertures 221 of the rotation plate 222.

Also, the above-described transportation device 200 serves as a left-right arrangement device for arranging a lateral side of the wad of paper money while moving it.

(3) Binding Device 300

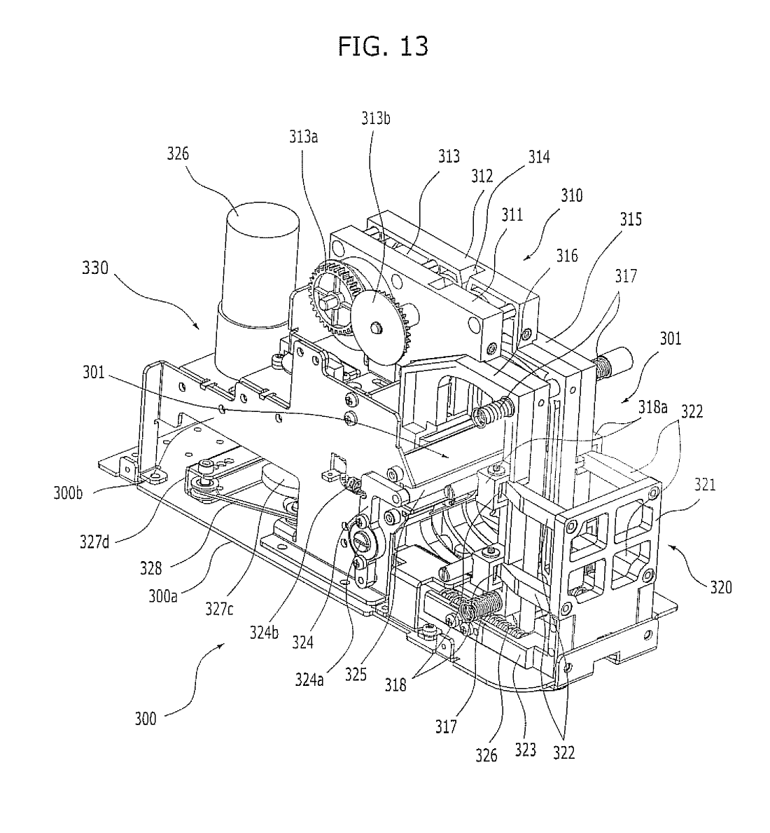

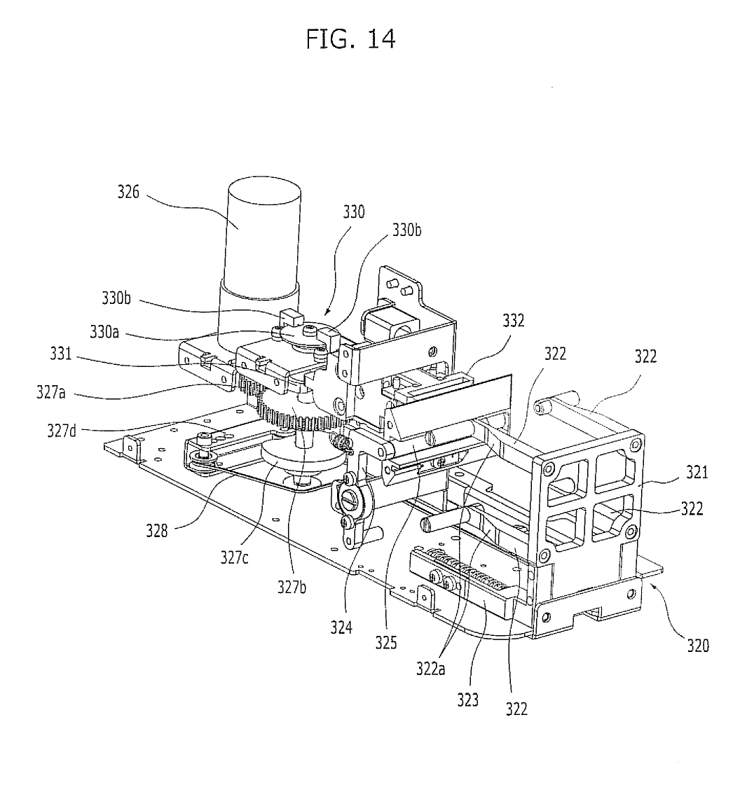

With reference to FIGS. 13 and 14, the binding device 300 being integrally constructed in one side of the counting device 100 and serving a role in binding a wad of paper money transported by the transportation device 200 will be described in detail. Especially, FIG. 13 is a perspective view showing the binding device of the multi-pocket paper money counting apparatus in accordance with a preferred embodiment of the present invention, and FIG. 14 is a perspective view showing the configuration of the binding device except for a roll paper guide unit in the multi-pocket paper money counting apparatus in accordance with the preferred embodiment of the present invention.

The binding device 300 includes: a base frame 300a; a paper money feeding inlet 301 formed in an extending line of a transportation direction of the wad of paper money from the transporting device 200; a roll paper 302 (refer to FIG. 2) for binding the wad of paper money fed into the paper money feeding inlet 301; a roll paper supplying means 310 being mounted on the base frame 300a for supplying and guiding the roll paper 302 around the wad of paper money; a curling means 320 giving an adequate curl to the wad of paper money by moving toward the roll paper supplying means 310, more particularly, by moving in a perpendicular direction to the wad of paper money; and a roll paper binding means 330 binding the wad of paper money in a predetermined curled state with the roll paper 302 supplied from the roll paper supplying means 310 and then cutting the bound roll paper 302.

Herein, in one surface of the roll paper 302, hotmelt adhesives are coated and dried.

The roll paper supplying means 310 is configured such that the roll paper 302 can be smoothly supplied to a place where the wad of paper money can be bound. The roll paper supplying means 310 comprises: a pair of left and right frames 311 and 312 having an approximate square shape, being arranged in parallel with a predetermined spacing distance in one upper side of the base frame 300a and guiding the roll paper 302 to be smoothly supplied; a roll paper supplying motor 313 being disposed between the pair of the left and right frames 311 and 312 which support the roll paper supplying motor 313 and being capable of making forward and reverse rotations; a roll paper supplying gear 313a mounting on an exterior side of one of the left and the right frames 311 and 312, i.e., on the exterior side of the left frame 311, and rotating by the roll paper supplying motor 313; a reduction gear 313b rotating by engaging with the roll paper supplying gear 313a; a roll paper feeing inlet 314 where the roll paper 302 is fed into, the roll paper feeding inlet 314 being opened in upper surfaces of the pair of left and right frames 311 and 312; a pair of roll paper feeding rollers (not shown) formed between portions of the pair of left and right frames 311 and 312 where the roll paper feeding inlet 314 is formed and one of the pair of feeding rollers being connected to a rotation shaft of the reduction gear 313b to make the pair of roller paper feeding rollers rotate by having a contact surface in an extending line of the roll paper feeding inlet 314 and thus to make the roll paper 302 fed into a space between the roll paper feeding rollers; a pair of roll paper guide members 315 and 316 being disposed in parallel in a forth direction from the pair of left and right frames 311 and 312 with a predetermined spacing distance, having a space for allowing the fed wad of paper money to be allocated inside, being specifically arranged such that the pair of the roll paper guide members 315 and 316 is allowed to move in an opposite direction from each other and guiding the roll paper 302 supplied through the pair of left and right frames 311 and 312 to circle around the fed wad of paper money by cooperating with the left and the right frames 311 and 312; and an elastic member 317 restoring the pair of roll paper guide members 315 and 316 to an original position.

Herein, on the inner side of a space between the pair of left and right frames 311 and 312 and the pair of roll paper guide members 315 and 316, there is provided a roll paper guiding passage (not shown) for guiding the roll paper 302 to go around the space.

Also, there are roll paper guide driving rollers 318 for moving the pair of roll paper guide members 315 and 316 in opposite direction, i.e., the direction making the pair of roll paper guide members 315 and 316 apart from each other as curling bars 322 of the curling means 320 move inwardly with a predetermined distance and contact both sides of the pair of roll paper guide members 315 and 316. That is, a plurality of supporting frame 318a having a shape of ‘ [symbol] ’ are placed in upper and lower sides of outer walls of the roll paper guide members 315 and 316, and the roll paper guide driving rollers 318 are arranged such that the roll paper guide driving rollers 318 rotate inside of each supporting frame 318a, but arranged with a predetermined distance from the outer walls of the roll paper guide members 315 and 316.

Therefore, when the curling bars 322 move into respective interstitial spaces created between each outer wall of the roll paper guide members 315 and 316 and each roll paper guide driving roller 318, the roll paper guide driving rollers 318 contact the curling bars 322 by rotating along the curling bars 322, respectively. As a result, the roll paper guide members 315 and 316 are moved in opposite direction.

The curling means 320 for providing an adequate curl to the wad of paper money which is, in turn, bound with the roll paper 302 supplied from the roll paper supplying means 310 includes: a movable base plate 321 having an approximate square shape and being perpendicularly mounted on the base frame 300a such that the movable base plate 321 is capable of moving towards the pair of roll paper guide members 315 and 316; the above-described curling bars 322 extending from each corner of the movable base plate 321 toward the pair of roll paper guide members 315 and 316, each having an angled surface 322a with a decreasing angle as going towards an end part of one surface of the selected curling bar 322, widening space between the pair of roll paper guide members 315 and 316 in opposite direction by being contacted to the respective roll paper guide driving rollers 318 as the curling bars 322 move together with the movable base plate 321, and pressing upper and lower portions of the wad of paper money fed into the space of the pair of left and right frames 311 and 312; interlocking bars 323 interlocking with the movement of the movable base plate 321; a pair of curling rotary moving bodies 324 each rotating around a respective central axle 324a and having one end pressed by the respective interlocking bar 323; a curling contact bar 325 being connected to the other end of each curling rotary moving body 324 and pressing a rear side, i.e., the side opposite to a side with which the curling bars 322 are contacted, of the wad of paper money fed by the rotation of the curling rotary moving bodies 324; a plurality of first elastic restoring members 326 restoring the movable base plate 321 into an original position; and a driving means for driving the movable base plate 321.

The curling rotary moving bodies 324 are mounted on a vertical frame 300b being perpendicularly mounted on the base frame 300a and supporting components. A plurality of second elastic restoring members 324b for restoring the curling rotary moving bodies 324 into an original position after the rotation of the curling rotary moving bodies 324 are formed in the other upper end of each curling rotary moving body 324 and in one upper side of the vertical frame 300b.

Herein, for detail description about the mechanism of the roll paper guide driving rollers 318 and the curling bars 322 for widening space between the pair of roll paper guide members 315 and 316 in opposite direction, when the curling bars 322 move as contacting the roll paper guide driving rollers 318, the roll paper guide driving rollers 318 move as riding on the respective angled surfaces 322a of the curling bars 322, thereby widening space between the pair of roll paper guide members 315 and 316 in opposite direction. The reason for widening space between the pair of roll paper guide members 315 and 316 is to block the pair of roll paper guide members 315 and 316 from interfering with subsequent activities of a cutter assembly 332 such as cutting and adhesion of the roll paper 302. More detail explanation of these activities will be provided later.

The driving means for driving the movable base plate 321 can be embodied in any form that allows the movable base plate 321 to move toward the pair of roll paper guide members 315 and 316. For instance, the driving means includes: a cam driving motor 326 disposed in one side of the base frame 300a; a driving gear 327a rotating by the cam driving motor 326; a transmission gear 327b engaging with the driving gear 327a; a curl driving cam 327c driving with the transmission gear 327b by having the same shaft to the transmission gear in one end of the transmission gear 327b; a curl driving lever 327d being rotatable around one end of the curl driving lever 327d as a rotation axle in the base frame 300a and rotating as the other end of the curl driving lever is interlocked with the curling driving cam 327c; and a wire 328 being a medium member for moving the curling means 320 by the rotation of the curl driving lever 327d.

Next, the roll paper binding means 330 comprises: a cutter driving cam 331 disposed in the other end of the transmission gear 327b by having the same shaft to the transmission gear 327b and driving together with the transmission gear 327b; the above mentioned cutter assembly 332 adhering the roll paper 302 used for binding the wad of paper money as the cutter assembly 332 is shifted to the rear side of the wad of paper money by the cutter driving cam 331 and cutting the adhered roll paper 302; and a detecting means for detecting the rotation of the cutter driving cam 331, i.e., that of the cam driving motor 326.

The cutter assembly 332 comprises: a heater 332a for adhering the roll paper 302; and a cutter 332b for cutting the adhered roll paper 302.

In addition, the roll paper binding means 330 is further provided with a sealing means. The sealing means may be constructed in various structures which are capable of performing a denotation of indicia such as a sealing date, a publisher, a person in charge on a binding interface portion of the roll paper, after the wad of the paper money is bound with the roll paper by the roll paper binding means.

The detecting means for the binding means comprises: a rotation plate 330a rotating around the same shaft to the cutter driving cam 331 and having detecting apertures (not shown) opened with a predetermined distance along a rim of the rotation plate 330a; and a groove sensor 330b being formed in one side of the rotation plate 330a such that a detecting portion of the groove sensor 330b faces towards the detecting apertures of the rotation plate 330a and detecting the rotation of the rotation plate 330a. Herein, the groove sensor 330b is a photo-sensor for detecting a driving of one rotation made by the cam driving motor 326.

In other words, the groove sensor 330b is a sensor for checking an initial state and a completed driving state based on the fact that, when the cam driving motor 326 completes one rotation, all relevant actuations of the binding device 300 completes one cycle. Also, the groove sensor drives the curling means 320 by making a half-rotation of the cam driving motor 326 when the roll paper 302 is jammed in the roll paper guiding passage of the roll paper guide members 315 and 316, so that the roll paper guide members 315 and 316 are opened in both directions, further resulting in an easy of removing the jammed piece of the roll paper 302.

In the detecting operation of the groove sensor 330b, the detecting operation is carried out where the detecting apertures 221 are not formed and, in contrast, the detecting operation is not carried out where the detecting apertures 221 are formed. Thus, with use of this detection signal, it is possible to detect degrees of the rotation made by the cam driving motor 326 in a forward direction or in a reverse direction.

In accordance with this preferred embodiment of the present invention, it is exemplified that the cam driving motor 326 driving the movable base plate 321 is used as a driving source for driving the cutter driving cam 331 of the roll paper binding means 330. However, it is still possible to use other additional driving sources for achieving the same goal.

The binding device 300 is covered by a case for protection. Also, a roll paper loading unit 340 where the roll paper 302 supplied to the roll paper supplying means 310 is loaded is formed in one exterior side of the case 300b, i.e., a rear side of the diagram shown in FIG. 2. Furthermore, a plurality of roll paper guide rollers 371 to 373 for guiding the roll paper 302 supplied in an unwound manner from the roll paper loading unit 340 to the roll paper supplying means 310 are formed with a predetermined distance in an upper exterior side of the case 300b.

Also, an unexplained reference numeral 521 is a binding key (refer to FIG. 1) for selecting the binding operation to the wad of paper money counted at the counting device. The binding key is formed in one side of the case 300b of the binding device 300.

Roll paper feeding keys are disposed in an exterior side of the case 300b of the binding device 300. Specifically, the roll paper feeding keys are composed of a roll paper supplying key and a roll paper releasing key, respectively. The roll paper supplying key 522a is used when a user manually feeds the roll paper 302 which is not fed into the space between the roll paper guide members 315 and 316 at an initial stage. The roll paper 302 precedently fed by the roll paper supplying key 522a is supplied by pressing a binding key 521 in a subsequent operation. The roll paper releasing key 522b serves a role in releasing the roll paper 302 from the roll paper guide members 315 and 316 when errors occur during the operation. If an error does not occur, the roll paper releasing key 522b is not used. Also, the roll paper releasing key 522b can be used when replacing the roll paper 302.

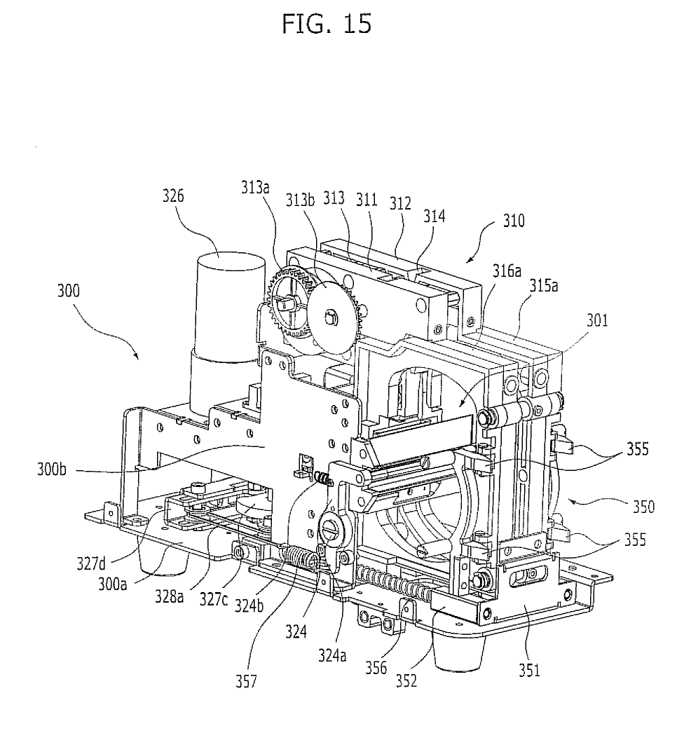

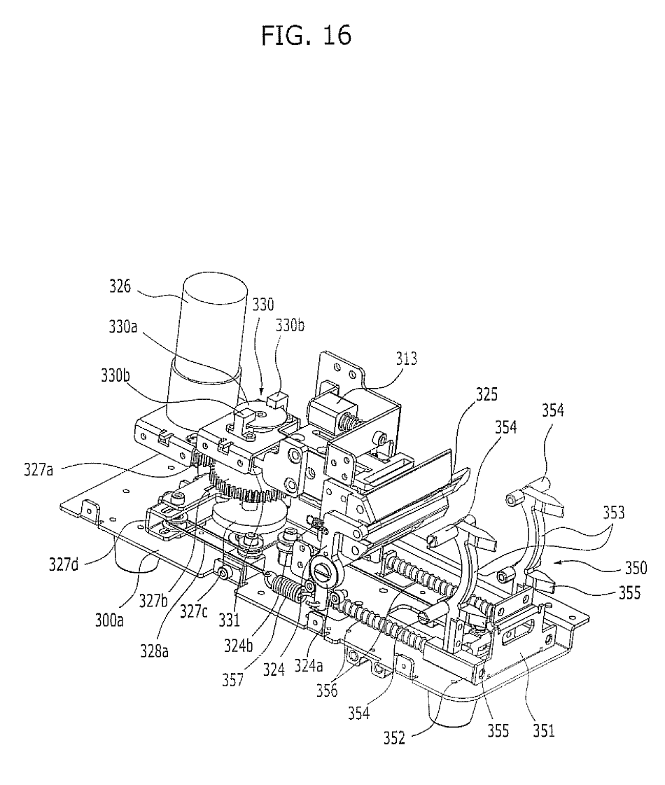

Meanwhile, referring to FIGS. 15 and 16, another preferred embodiment of the binding device 300 will de explained in detail. FIG. 15 is a perspective view showing a binding device of the paper money counting apparatus in accordance with another preferred embodiment of the present invention. FIG. 16 is a perspective view showing the configuration of the binding device except for a roll paper guide means in accordance with said another preferred embodiment of the present invention.

The binding device 300 includes: a base frame 300a; a paper money feeding inlet 301 formed in an extending line of the transportation direction of the wad of paper money from the transporting device 200; a roll paper 302 (Refer to FIG. 2) supplied to bind a wad of paper money fed into the paper money feeding inlet 301; a roll paper supplying means 310 being mounted on the base frame 300a and serving a role in supplying the roll paper 302 and guiding the roll paper 302 to circle around the wad of paper money; a curling means 350 providing an adequate curl to the wad of paper money by moving toward the roll paper supplying means 310, more particularly, by moving in a perpendicular direction to the wad of paper money; and a roll paper binding means 360 binding the wad of paper money in a predetermined curled state with the roll paper 302 supplied from the roll paper supplying means 310 and then cutting the bound roll paper 302.

Since this binding device 300 except for the curling means 350 and the roll paper binding means 360 is identical to the binding device provided in accordance with the precedently described preferred embodiment of the present invention, detailed description about those identical components will be omitted. Herein, the roll paper guide members 315a and 316a modified corresponding to changes in the shape of curling means 350 will be described along with describing the curling means 350.

The curling means 350 in accordance with another preferred embodiment serves a role in providing an adequate curl to the wad of paper money prior to binding the wad of paper money with the roll paper 302 supplied from the roll paper supplying means 310. The curling means 350 comprises: a movable base plate 351 having an approximate square shape and being perpendicularly mounted on the base frame 300a such that the movable base plate 351 is capable of moving towards the pair of roll paper guide members 315a and 316a; a pair of bottom plates 352 extending from both end sides of the movable base plate 351 towards the roll paper guide members 315a and 316a; a plurality of projection plates 353 each projecting from an upper surface of the bottom plate 352 in an upward direction; a plurality of curling bars 354 formed in bottom and top parts of projection plates 353 and pressing upper and lower portions of the wad of paper money fed into a space of a left and a right frames 311 and 312 as the curling bars 354 move along the movable base plate 351; a plurality of contact plates 355 being disposed on portions of the projection plates 353 facing to portions where the curling bars 354 are formed and contacting both sidewalls of the roll paper guide members 315a and 316a prior to making a forward movement; a plurality of first elastic members 356 each formed in a forth side of the bottom plate 353 and inducing the elastic movement of the movable base plate 351; a pair of curling rotary moving bodies 324 each rotating around a respective central axle 324a and being connected with the first elastic members 356 in one side of lower end thereof; a curling contact bar 325 extending from one side of the upper end of each curling rotary moving body 324 and pressing a rear side, i.e., the side facing to a surface to which the curling bars 354 make a contact, of the wad of paper money fed by the rotation of the curling rotary moving bodies 324; a plurality of second elastic members 357 for providing elasticity in an opposite direction to the first elastic members 356 by being formed in the other side of lower end of the curling rotary moving body 324; a plurality of elastic restoring members 324b each being formed in the other side of upper end of each curling rotary moving body 324 for restoring the curling rotary moving bodies 324 into an original position; and a driving means for driving the movable base plate 351.

The pair of curling rotary moving bodies 324 is mounted on a vertical frame 300b which supports components by being placed in perpendicular to the base frame 300a. Also, the projection plate 353 is formed in an arc shape having a predetermined curvature, and the curling bars 354 are formed at a starting point and at an end point of the arc, respectively.

Herein, a separation elastic member (not shown) is formed between the roll paper guide members 315a and 316a to provide left and right movements of the roll paper guide members 315a and 316a. Before the movable base plate 351 moves, the contact plates 355 are in a state of making a contact with outer walls of the roll paper guide members 315a and 316a. Thus, left and right movements of the roll paper guide members 315a and 316a are restrained by the contact plates 355. Also, the separation elastic member (not shown) under a compressed state exerts a repulsion force that makes the roll paper guide members face in opposite.

The driving means for driving the movable base plate 351 can be embodied in any type as long as the movable base plate 351 can move towards the roll paper guide members 315a and 316a. For example, the driving means includes: a cam driving motor 326 disposed in one side of the base frame 300a; a driving gear 327a rotating by the cam driving motor 326; a transmission gear 327b engaging with the driving gear 327a; a curl driving cam 327c driving with the transmission gear 327b by having the same shaft to the transmission gear 327b in one end part of the transmission gear 327b; a curl driving level 327d being rotatable around one end as a rotation axle in the base frame 300a and rotating as the other end of the curl driving lever 327d is interlocked with the curling driving cam 327c; and a wire 328 being a medium member for moving the curling means 320 by the rotation of the curl driving lever 327d.

Herein, one end of the wire 328a is connected to one of the second elastic member 357, and the other end of the wire 328a is connected to the movable base plate 351.

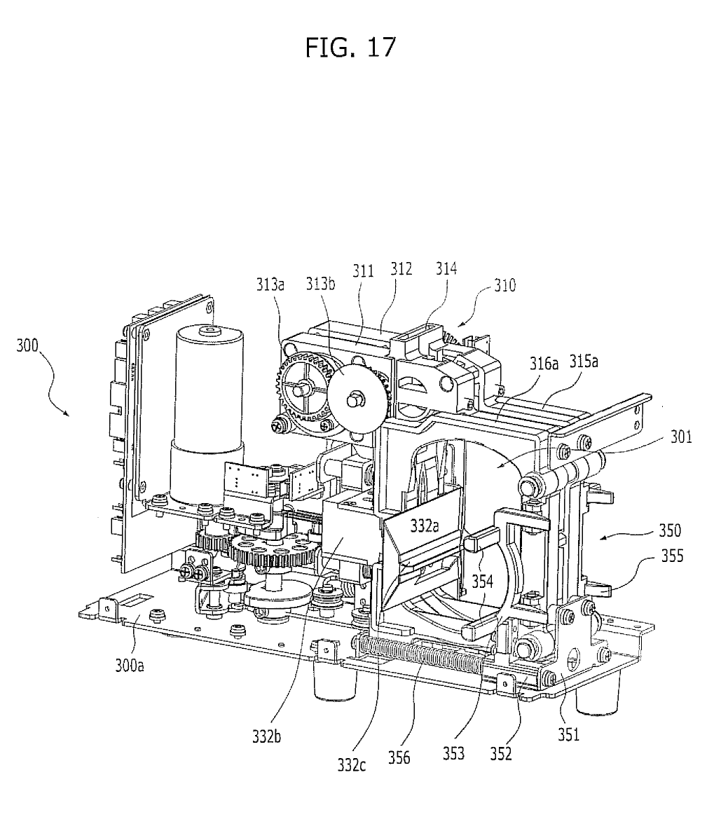

Next, referring to FIG. 17, still another preferred embodiment of the binding device 300 will be described in detail. FIG. 17 is a perspective view showing a binding device of the paper money counting apparatus in accordance with still another preferred embodiment of the present invention. The binding device 300 is similar to the above-described binding device except that some parts of the above-described binding device are omitted. Therefore, in the binding device 300 in accordance with the still another embodiment of the present invention, components identical to that of the above-described binding device is denoted by the same reference numerals, detailed description about those identical components will be omitted. As described below, it will be described with relation to different components.

The binding device according to the still another embodiment has a structure in which the curling rotary moving bodies 324 for curling the wad of paper money and the associated components are omitted. The binding device of the present embodiment includes a projection plate 332c transversely extending on a front of the heater (not shown) of the cutter assembly 332b. Therefore, when the curling bars 354 press the upper and lower portions of the wad of paper money, a middle portion of the wad of paper money contacts with the projection plate 332c to thereby make the wad of the paper money to be curled state. Since the binding device of still another embodiment as constructed above has a smaller number of components than that of the above-described binding devices, it has advantage effects such as reduction of a number of parts and reduction of manufacturing processes.

(4) Arrangement Device 400

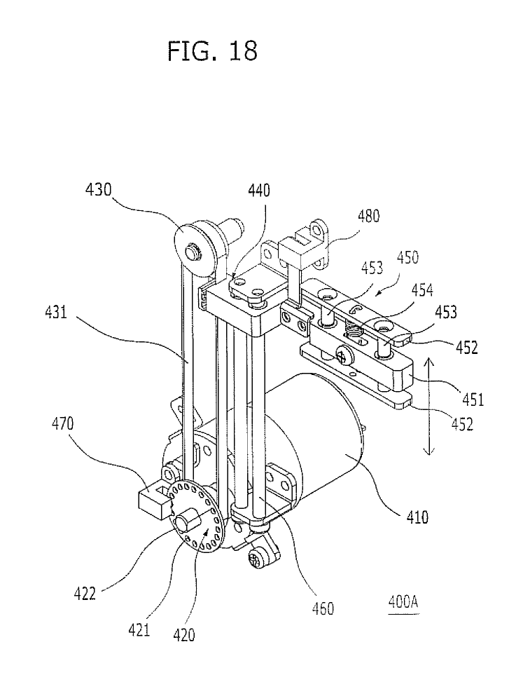

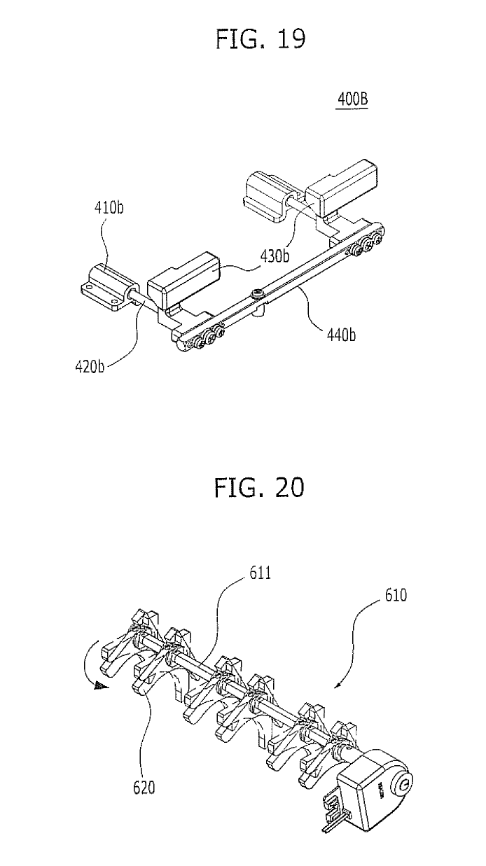

With reference to FIGS. 18 and 19, the arrangement device 400 for arranging the wad of paper money which is counted by the counting device 100 and then is stacked on the stacker will be described. FIG. 18 is a perspective view showing a up-down arrangement device constructed in the paper money counting apparatus in accordance with the present invention, FIG. 19 is a perspective view showing a front-rear arrangement device constructed in the paper money counting apparatus in accordance with the present invention.

The arrangement device 400 essentially includes an up-down arrangement device 400A and a front-rear arrangement device 400B. The up-clown arrangement device 400A arranges the wad of paper money up and down before binding the wad of paper money transported by the binding device 300. The up-down arrangement device 400A is mounted in a place where the wad of paper money is fed by the transporting device 200 and bound by the binding device 300, i.e., in the paper money feeding inlet side of the binding device 300. The front-rear arrangement device 400B is mounted in a place where the stacker 112 of the counting device 100 puts opposite thereto.

First, with reference to FIG. 18, the up-down arrangement device 400A for arranging the wad of paper money in upward and downward will be described.

As shown, the up-down arrangement device 400A includes: an arrangement driving motor 410 capable of making forward and reverse rotations; an arrangement driving pulley 420 being connected to a rotation shaft of the arrangement driving motor 410 and having a rotation plate 422 in one side, wherein the rotation plate 422 has apertures 421 opened with a predetermined distance along a rim of the rotation plate 422; an arrangement driven pulley 430 being disposed with a predetermined distance from the arrangement driving pulley 420 in an upward direction and rotating by a driving force transmitted from the arrangement driving pulley 420 through the use of an arrangement driving belt 431 as a medium; an arrangement base block 440 fixed in one portion of the arrangement driving belt 431 and making upward and downward movements along with the movement of the arrangement driving belt 431; an arrangement means 450 moving upwardly and downwardly along with the movement of the arrangement base block 440 by being adjoined with the arrangement base block 440, thereby arranging the wad of paper money in upward and downward directions and in left and right directions; at least one guide members 460 guiding the arrangement base block 440 to direct upwardly and downwardly; and a control means controlling the upper and lower movements of the arrangement base block 440.

Said at least one guide members 460 penetrate the arrangement base block 440 and are preferably formed in a bar shape to allow the arrangement base block 440 to slide upwardly and downwardly along said at least one guide members 460. Also, it is preferable to form said at least one guide members 460 in pairs for a stable support and movement of the arrangement base block 440.

Also, a slide bearing (not) can be formed inside of the arrangement base block 440 through which said at least one guide members 460 pass in order to make the arrangement base block 440 slide upwardly and downwardly along said at least one guide members 460.

The control means includes: an arrangement encoder sensor 470 controlling forward and reverse rotations of the arrangement driving motor 410 to thereby control upward and downward movements of the arrangement base block 440; and an arrangement groove sensor 480 being formed in one side of the arrangement base block 440 and detecting an original position of the arrangement base block 440.

In case of controlling a position of the arrangement base block 440 by the arrangement encoder sensor 470, the original position is first decided by using the arrangement groove sensor 480. The arrangement groove sensor 480 is also used to initialize the position of the arrangement driving motor 410 when errors occur.

The arrangement encoder sensor 470 is a photo-sensor, and a detecting portion of the arrangement encoder sensor 470 faces to the apertures 421 of the rotation plate 422 of the arrangement driving pulley 420. Therefore, when the arrangement driving pulley 420 rotates, the detection operation is carried out where the apertures 421 do not exist, but the detection operation is not carried out where the apertures 421 exist. As a result of this selective detection operation, it is possible to detect a degree of forward or reverse rotation made by the arrangement driving motor 410.

As mentioned above, the arrangement means 450 moves upwardly and downwardly along with the movement of the arrangement base block 440 by being adjoined with the arrangement base block 440, thereby arranging the wad of paper money in upward and downward directions. The arrangement means 450 includes: a frame 451 connected to the arrangement base block 440; contact plates 452 formed in upper and lower sides of the frame 451; a plurality of connecting bars 453 connecting the contact plates 452 with each other as passing through the frame 451 by giving movability to the contact plates 452; and an elastic body 454 elastically supporting between the frame 451 and one contact plate 452 disposed in the upper side of the frame 451.

Herein, the arrangement driving pulley 420, the arrangement driven pulley 430 and the arrangement driving belt 431 are media for driving the arrangement base block 440 by a driving force provided from the arrangement driving motor 410. Thus, it is known that these media can be formed in any type as long as the driving force of the arrangement driving motor 410 can be transmitted to the arrangement base block 440.

Next, with reference to FIG. 19, the front-rear arrangement device 400B for arranging the wad of paper money in forward and backward will be described.

The front-rear arrangement device 400B includes: at least one base blocks 410b being mounted on the base frame 110a and forming a guide hole therein; guide bars 420b being guarded to and fro through the guide hole of the base blocks 410b, respectively; contacting blocks 430b being formed on an one end of the guard bars 420b and being exposed to an outside of the counting device 100, so that the contacting blocks contact to a rear side of the wad of paper money stacked on the stacker 112; a connection member 440b for connecting the contacting blocks 430b with each other; and a driving unit (not shown) for driving the guide bars 420b.

Herein, the connection member 440b is disposed at a position inside of the counting device 100. As shown in drawings, it is preferable that the contacting blocks 430b is bent and connected to the connecting member 440b, and only the contacting blocks 430b is constructed to be exposed to outside of the counting device 100

Also, in the present embodiment of the front-rear arrangement device 400B, although base blocks 410b, guide bars 420b and contacting blicks 430b are exemplified in pairs, it is possible to construct a single component respectively, in which the connecting member is omitted.

(5) Selection Discharging Device

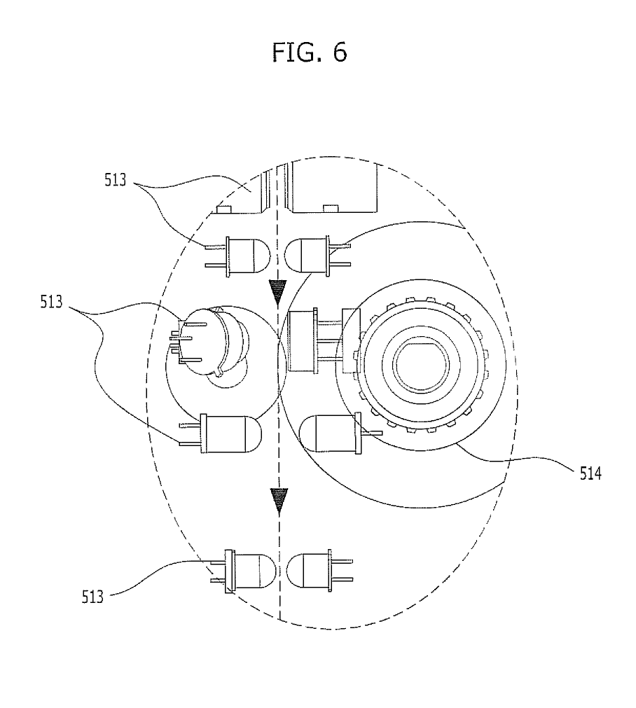

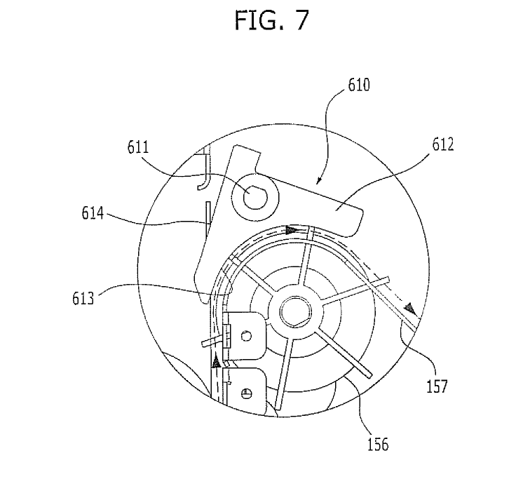

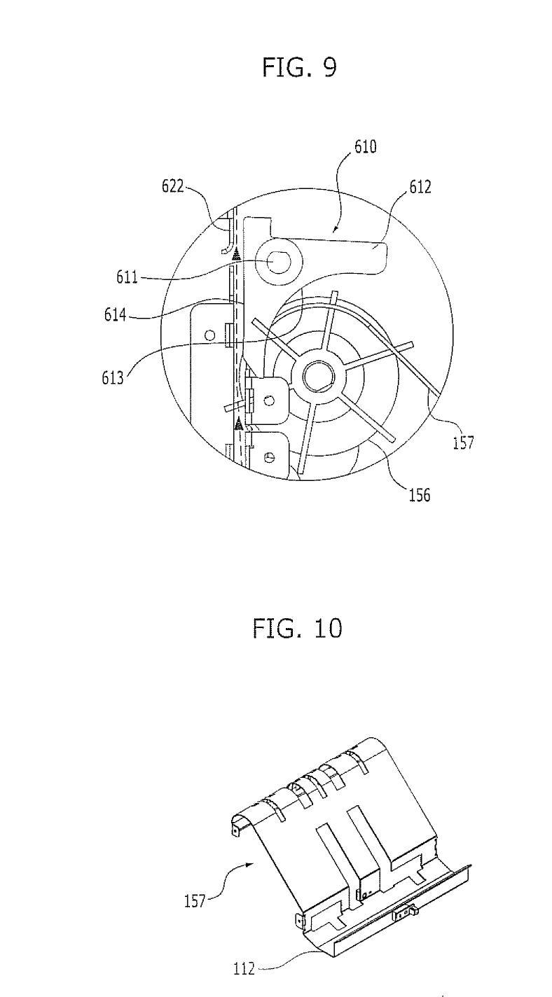

With reference to FIGS. 5 to 9, a selection discharging device for discriminating paper money except for paper money to be counted and for discharging it outside of the counting device 100 will be described. FIG. 6 is an enlarged view of “A” portion in FIG. 5. FIGS. 7 and 9 are a side views showing a path changing unit (selector) configured in the selection discharging device, respectively, wherein FIG. 7 is a side view when the path changing unit is positioned in the normal counting mode, and FIG. 9 is a side view when the path changing unit is positioned in the discriminating mode.

As shown in drawings, the selection discharging device of the paper money counting device in accordance with the present invention includes: a sensor unit 513 being disposed at upstream side of paper money transportation path in order to discriminate different denomination notes, counterfeit notes, front-rear side of paper money and upper-lower side of paper money (namely, sort function); a path changing unit 610 disposed at downstream side of the paper money transportation path in order to allowing paper money to be selectively transported into a path for paper money to be counted or a path for other paper money except for paper money to be counted (hereinafter, referred as different denomination notes); a driving unit (not shown) for driving the path changing unit 610; a transportation guide unit 620 for different denomination notes forming a transportation path for different denomination notes transported by the path changing unit 610; a transporting unit for different denomination notes being disposed at the transportation path for different denomination notes for transporting the different denomination notes; a stacker 640 for placing the different denomination notes which is guided by the transportation guide unit 620 and is discharged outside of the counting device.

The sensor unit 513 is configured to sensor or sensors such as a contact image sensor (CIS), a infrared sensor (IR sensor), an ultraviolet sensor (UV sensor), a magnetic sensor (MG sensor), a color recognition sensor, in single or in combination.

With reference to FIGS. 7, 9 and 20, the path changing unit 610 will be described. FIG. 20 is a perspective view showing the path changing unit (selector) configured in the selection discharging device provided with the multi-pocket paper money counting apparatus provided with the auto binding-function in accordance with the present invention.

As shown in the drawings, the path changing unit 610 includes: a rotary shaft 611 rotatablely mounted the frame configured in the counting device 100; a driving unit (not shown) for driving the rotary shaft 611; and a plurality of guide members 612 integrally formed on the rotary shaft 611 along the longitudinal direction of the rotary shaft for selectively guiding paper money to a transportation path for paper money to be counted and a transportation path for different denomination notes.

As shown in FIG., 7, 9 and 20, the plurality of guide members 612 is formed into an approximate triangle shape having a first guide surface 613 as a lower surface for guiding paper money to the transportation path for paper money to be counted and a second guide surface 614 as a side surface adjacent to the lower surface for guiding different denomination notes to the transportation path for different denomination notes. As shown in FIGS. 7 and 9, the first guide surface 613 is formed into an arc shaped surface corresponding to the circumferential surface of the third feeding roller 156, so that the first guide surface 613 constitutes a part of the transportation path for paper money to be counted.

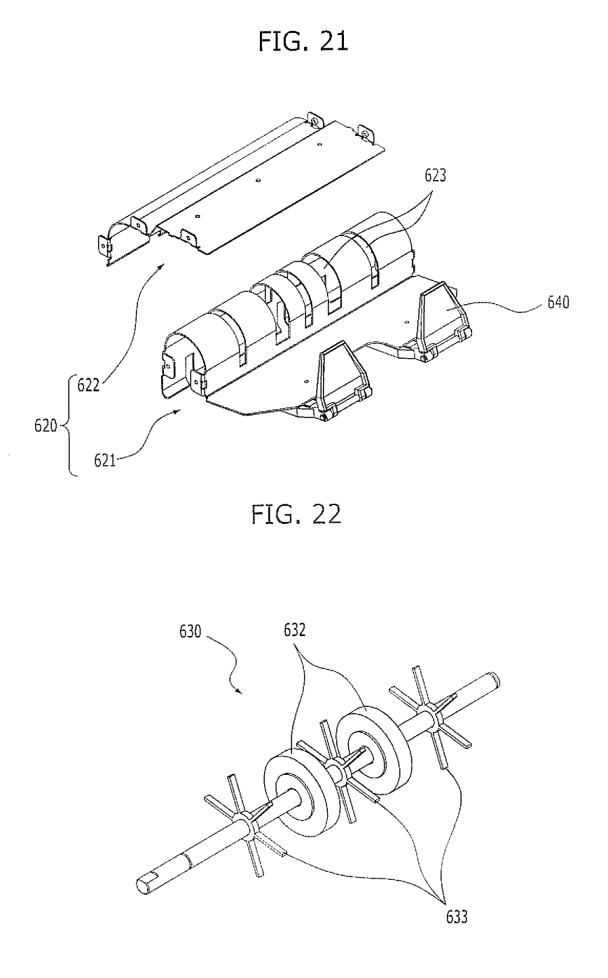

FIG. 21 is an exploded-perspective view showing a transportation guide unit 620 for different denomination notes. As shown in the drawing, the transportation guide unit 620 for different denomination notes includes an upper guide member 621 and a lower guide member 622 both formed into guide plates for transporting different denomination notes. The lower guide member 621 has an one end which is exposed outside and coupled to the stacker 640.

The lower guide member 621 at its one side has a half cylindrical shaped portion having an opening 623 through which at least one contacting rollers 632 and at least one small wings 633 of the transporting unit 630 to be described below are exposed outside.

FIG. 22 is a perspective view showing a part of a transporting unit for different denomination notes in accordance with the present invention. The transporting unit 630 for different denomination notes includes: a rotary shaft; at least one contacting rollers 632 formed on the rotary shaft; at least one idlers 631 facing to and contacting with the contacting rollers 632; and at least one small wings 632 formed on the rotary shaft between the contacting rollers 632 for transporting paper money of different denomination notes by contacting with it.

(6) Central Control Device 500

Referring to FIG. 23, detailed description on the central control device 500 will be provided hereinafter. FIG. 23 is a configuration diagram showing a central control device configured in the paper money counting apparatus in accordance with the present invention.

As shown in the drawing, the central control device 500 receives and outputs signals from a roll paper detecting sensor 511 for detecting whether a piece of roll paper 302 is supplied, a supplied paper money detecting sensor 512 for detecting whether paper money are supplied to the paper money receiving unit 111, the sensor unit 513 for defecting paper money in the middle of transportation so as to discriminate different denomination notes which is transported and discharged along the transportation path, the groove sensor 330b for detecting an initial position of the cam driving motor 326 and for detecting a half-rotation of the cam driving motor 326 to widen the space between the pair of foil paper guide members 315 and 316 for the purpose of easily removing pieces of roll paper jammed in between the roll paper guide members 315 and 316, the transportation groove sensor 290 for detecting whether a wad of paper money is transported (namely, for detecting the movement of the transportation base block 250), the transportation encoder sensor 280 for detecting a location of the transportation driving motor 210, a roll paper encoder sensor 518 for controlling supply and discharge of the roll paper 302 by detecting an encoder plate placed in opposite to a shaft of the reduction gear 313b driving by engaging with the roll paper supplying gear 313a, the arrangement groove sensor 470 for detecting an original position of the arrangement base block 450, and the arrangement encoder sensor 480 for controlling the position of the arrangement base block 450. Also, the central control device 500 controls the cam driving motor 326, the transportation driving motor 210, the roll paper supplying motor 313, the up-down arrangement driving motor 410, the front-rear arrangement driving unit, the path change driving unit, and the cutter assembly 332. Furthermore, the central control device 500 receives signals from the binding key 521 for selecting the binding function of the counted paper money and roll paper feeding keys 522a and 522b (refer to FIG. 1) to control corresponding mechanisms.

The roll paper feeding keys 522a and 522b disposed in an exterior side of the binding device 300 are a roll paper supplying key and a roll paper releasing key, respectively. The roll paper supplying key 522a is used when a user manually feeds a piece of the roll paper 302 which is not fed into the space between the roll paper guide members 315 and 316 at an initial stage. The roll paper 302 precedently fed by the roll paper supplying key 522a is supplied by a binding key 521 in a subsequent operation.

The roll paper releasing key 522b serves a role in releasing pieces of the roll paper 302 from the roll paper guide members 315 and 316 when errors occur during the operation. If an error does not occur, the roll paper releasing key 522b is not used. Also, the roll paper releasing key 522b can be used when replacing the roll paper 302.

(7) Discharging Device

The discharging device is mounted at a bottom front side of the base frame 300a of the binding device 300 in an extending line of a transportation direction of the wad of paper money from the transporting device 200. The discharging device includes: a discharge driving bar of which one end moves as being pressed by the transportation base block of the transportation device 200; a plurality of restoring springs restoring the moved discharge driving bar into an original position; at least more than one discharge guiding blocks fixed in a bottom surface of the base frame to allow the discharge driving bar to be guided as the discharge driving bar passes through the discharge guiding blocks; and a discharge member formed in the other end of the discharge driving bar and discharging the wad of paper money bound by the binding device 300. The discharge member is a plate placed in perpendicular to the other end of the discharge driving bar.

Among the above described driving components or driving units, the motors operating as a driving source are capable of making forward and reverse rotations and are controlled by the central control device 500.

In the technical scope and spirit of the invention, it is understood for those skilled in the art that the multi-pocket paper money counting apparatus provided with the auto-binding function in accordance with the present invention may constructed as follows.

The multi-pocket paper money counting apparatus provided with the auto-binding function according to an embodiment of the present invention comprises: a counting device for counting predetermined amount of paper money and displaying the count result by an inputted command and for discharging the counted paper money outside; a transporting guide unit configured to be disposed inside of the counting device and forming a transporting path which includes at least a first path through which paper money to be counted is transported and a second path through which paper money except for paper money to be counted is transported; a paper money transporting unit disposed on the transporting path for transporting paper money; a sensor unit for defecting amount of paper money, different denomination notes, counterfeit notes, front-rear side of paper money and upper-lower side of paper money among paper money in the middle of transportation;

a path changing device disposed on the transporting path for allowing paper money to be selectively transported into the first path or the second path; a central control device configured to control the associated components; and pocket units each formed on outside of the counting device for displacing paper money discharged from the counting device through the first path and the second path respectively.

Also, the multi-pocket paper money counting apparatus further comprises: a transporting device for transporting a wad of paper money which are counted from the counting device and discharged through the first path into a predetermined place; and a binding device integrally formed in one side of the counting device in order to bind the wad of paper money transported by the transportation device. In addition, the paper money counting apparatus further comprising an arrangement device for arrange the wad of paper money which are discharged from the counting device and transported by the transportation device.

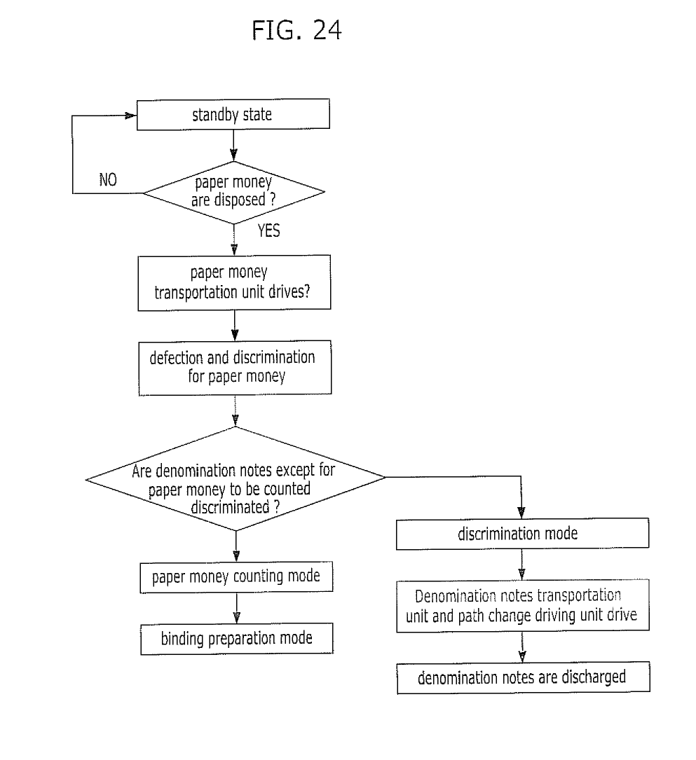

Meanwhile, with reference to FIG. 24, operation of the paper money counting apparatus provided with the auto binding-function will be described in accordance with the present invention. FIG. 24 is a flowchart for describing steps of the operation in the multi-pocket paper money counting apparatus provided with the auto-binding function in accordance with the present invention.

In the description of operation steps as described below, the operation of the counting apparatus will be described a normal counting mode and a discriminating mode, respectively.

(1) Normal Counting Mode

First, when a user puts a predetermined number of paper money to be counted on the paper money receiving unit 111 in standby state, the supplied paper money detecting sensor 512 senses this action. Then, the main motor 120 and the discharge motor (not shown) are automatically driven by a command from the central control device 500. When the paper money is not put on the paper money receiving unit 111, the standby state is maintained.

As the main motor 120 and the discharge motor are driven, the pick-up roller 151, the base roller 152, the reverse roller 153, the first to third feeding rollers 154 to 156, and the discharging wheel 130 interlocking with this automatic driving start rotating, and among the predetermined number of paper money placed on the paper money receiving unit 111, the pick-up roller 151 sequentially picks-up pieces of the paper money in order from the bottom one to the top one with a predetermined time-interval. The picked-up paper money is fed into an upper side of the base roller 152.

Next, the pieces of paper money fed into the upper side of the base roller 152 are sequentially transported along a circumferential surface of the first and the second feeding roller 154, 155 by the rotation of the first and the second feeding roller 154, 155, and then are individually injected in between the discharge wings 131 of the discharge wheel 130. Thereafter, the pieces of paper money are stacked on the stacker 112 by rotation of the discharge wings 131. In the course of the transportation, the detecting unit disposed in the paper money transportation path counts the passed number of paper money, and the discriminating sensor units 513 disposed in the paper money transportation path discriminate whether the pieces of paper money is paper money to be counted or not. In other ward, the discriminating sensor units discriminate different denomination notes and counterfeit notes from paper money to be counted.

In the discriminating operation, when the different denomination notes and counterfeit notes are not discriminated, the path changing unit 610 maintains the transportation path for transporting paper money to be counted as shown in FIG. 7. Then, the counted paper money move in an arrow direction shown in FIG. 5 and are stacked on the stacker 112.

The number of paper money counted by the detecting units is displayed on the light emitted diode (LED) display 141. If the input operation for all pieces of paper money is completed from the paper money receiving unit 111, the supplied paper money detecting sensor 512 sense this action, and then the central controlling apparatus 500 stops the main motor 120 and the discharge motor (not shown) from driving.

During or after the count of paper money at the counting device 100, the roll paper supplying motor 313 of the binding device 300 is driven by a command from the central control device 500 when a user pushes the binding key 521. As a result, the roll paper supplying gear 313a connected with the roll paper supplying motor in one axle starts driving.

Subsequent to the driving of the roll paper supplying gear 313a, the roll paper 302 is guided from the roll paper stacking unit 340 by the plurality of roll paper guiding rollers 371 and is fed by the roll paper feeding rollers (not shown) allocated at bottom of the roll paper feeding inlet 314 of the left frame 311 and the right frame 312. The roll paper 302 fed by the roll paper feeding rollers is supplied along the roll paper guiding passage (not shown) formed inside of the space between the pair of left and right frames 311 and 312 and the pair of roll paper guide members 315 and 316. Herein, the roll paper 302 is supplied under a state that a user manually feeds the roll paper 302 into a space between the roll paper feeding rollers through a roll paper feeding inlet 314 at an initial operation stage.

Meanwhile, before and after the wad of the counted paper money discharged to the stacker 112 from the counting device 100 is transported into the binding device 300 or during the wad of the counted paper money discharged to the stacker 112 is transported into the binding device 300 with use of the transporting device 200, the arrangement device 400 (namely, the up-down arrangement device 400A and the front-rear arrangement device 400B) arranges the wad of the counted paper money by a command from the central control device 500.

In an operation of the front-rear arrangement device 400B, the guide bars 420b of the front-rear arrangement device 400B move forward by the associated driving unit. And, the contacting blocks 430b formed on the one end of the guide bars 420b contact with the rear side of the paper money stacked on stacker 112 and arrange the stacked paper money. And then the guide bars 420b and the contacting blocks 430b move backward and return to those original position.

Meanwhile, in an operation of the up-down arrangement device 400A, the arrangement driving motor 410 of the arrangement device 400 drives, and the arrangement driving pulley 420 connected with the arrangement driving motor 410 in one axle, the arrangement driven pulley 430 and the arrangement driving belt 431 connecting the arrangement driving pulley 420 with the arrangement driven pulley 430 in one orbit are driven by forward and reverse rotations of the arrangement driving motor 410. As a result, the arrangement base block 440 moves as being guided along the arrangement guide members 431.

As the arrangement driving belt 431 drives, the arrangement base block 440 fixed in the arrangement driving belt 431 starts moving, and as a result, the arrangement means 450 moves to a predetermined downward position. The predetermined position of the arrangement means 450 is controlled by the arrangement encoder sensor 470.

The transportation driving motor 210 of the transporting device 200 is driven by a command from the central control device 500. Then, as the transportation driving motor 210 drives, the transportation driving pulley 220 connected with the transportation driving motor 210 in one side, the plurality of transportation driven pulleys 241 to 243 and the transportation driving belt 230 connecting the transportation driving pulley 210 with the plurality of transportation driven pulleys 241 to 243 in one orbit start driving. Hence, the transportation driving belt 230 is guided along the guide members 260, and as a result of these sequential actions, the wad of paper money placed on the stacker 112 is transported.

As the transportation driving belt 230 drives, the transportation base block 250 connected to the transportation driving belt 230 and the moving bar 270 integrated with the transportation base block 250 move towards the binding device 300.

At this time, the wad of paper money is transported as much as the predetermined transportation distance set by a user, and the transportation encoder sensor 280 controls the transportation distance.

Under the state that the one side of the wad of paper transported by the transporting device 200 is contacted to and supported by the moving bar 270, the wad of paper money is transported until the other side of the wad of paper money touches the arrangement means 450 of the arrangement device 400. At this position, the transportation base block 250 stops moving.

Under the stopped transportation, the transportation base block 250 moves with a predetermined distance to a counter-direction of the transportation. That is, the transportation base block 250 moves backward to a range of distance from approximately 10 mm to approximately 20 mm. Subsequent to this backward movement, the transportation base block 250 moves forward to push the wad of paper money to the arrangement base block 450. These backward and forward movement steps are repeated three times to arrange the wad of paper in left and right directions.

Afterwards, the transportation base block 250 moves backward again with a predetermined distance, and the arrangement driving motor 410 of the arrangement device 400 is simultaneously driven to make the interlocked arrangement base block 450 move to an initial starting position detected by the grooved arrangement sensor 480.

Then, the transportation driving motor 210 of the transporting device 200 is driven again. The interlocked transportation base block 250 moves forwardly, and the wad of paper money is transported inside of the binding device 300 by the moving bar 270.

As the wad of paper money moves inside of the binding device 300 by the transportation driving motor 210, the arrangement driving motor 410 of the arrangement device 400 drives to make the interlocked arrangement base block 450 driven downwardly. The driving distance is controlled by the arrangement encoder sensor 470, and the arrangement means 450 moving downwardly presses a top surface of the wad of paper money. These upward and downward movements of the arrangement means 450 are repeated in a predetermined number of times, e.g., approximately three times, thereby carrying out the upward and downward arrangement of the wad of paper money.

Next, the moving bar 270 moves the wad of paper money inside of the binding device 300 by the transportation driving motor 210 of the transporting device 200, thereby carrying out the left and right arrangement of the wad of the paper money.

Subsequently, when the wad of paper money is completely transported to the binding device 300 through the transportation device 200, the cam driving motor 326 of the binding means 330 rotates by a command from the central control device 500, and the driving gear 327a is driven by the rotation of the cam driving motor 326. Also, the rotation of the cam driving motor 326 drives the transmission gear 327b connected with the driving gear 327a. If the transmission gear 327b is driven, the curl driving cam 327c and the cutter driving cam 331 respectively connected to opposite portions of the axle of the transmission gear 327b are also driven.

At this time, the driving of the curl driving cam 327c makes the driving lever 327d rotate around one end as an axis, and the driving lever 327d pulls the wire 328 as the driving lever 327d rotates. The pulled wire 328 moves the curling means 320 connected to the wire 328 toward the roll paper guide members 315 and 316 in which the wad of paper money is disposed inside.

With the movement of the curling means 320, the curling bars 322 of the curling means 320 also moves, thereby pressing left and right corners and upper and lower corners of the wad of paper money disposed inside of the space created between the pair of left and right frames 311 and 312 and the pair of roll paper guide members 315 and 316. Simultaneously, when the curling bars 322 of the curling means 320 move, the roll paper guide driving rollers 318 formed in both exterior sides of the roll paper guide members 315 and 316 moves as riding on the angled surface 322a of each curling bar 322 to thereby make the roll paper guide members 315 and 316 widen space between the pair of left and right frames 311 and 312.

As simultaneous to the movement of the roll paper guide members 315 and 316, the curling means 320 also moves, so that the interlocking bars 323 interlocked with the curling means 320 move forward, pushing each one end of the curling rotary moving bodies 324.

As the curling rotary moving bodies 324 rotates, the curling contact bar 325 formed on the other end of each curling rotary moving body 324 serves a role in smoothly curling the wad of paper money by pressing a central portion of one side of the wad of paper money opposite to a side in which four points are pressed by the curling bars 322 of the curling means 320 in state that the wad of paper money is disposed inside of the space created between the pair of left and right frames 311 and 312 and the pair of roll paper guide members 315 and 316.

Under this state, the roll paper supplying motor 313 makes a reverse rotation by a command from the central control device 500 to thereby firmly bind the curled wad of paper money in the roll paper guiding passage formed inside of the space between the pair of left and right frames 311 and 312 and the pair of the roll paper guide members 315 and 316. At this time, since the pair of roll paper guide members 315 and 316 move in left and right directions by the curling means 320, there is not interference between the roll paper 302 and the pair of roll paper guide members 315 and 316 even if the roll paper 302 departs from the roll paper guiding passage.

The wad of paper money is curled by the curling means 320 as the curl driving cam 327c drives. Also, while the curled wad of paper money is bound with the roll paper 302, the cutter driving cam 327c also simultaneously drives, resulting that the cutter assembly 332 moves forward to a rear side of the wad of paper money. Subsequently, the cutter assembly 322 adheres the roll paper 302 supplied to the roll paper supplying means 310 and cuts the bound roll paper 302 thereafter.

Herein, the moments of curling the wad of paper money, reversely supplying the roll paper 302 and adhering and cutting the roll paper 302 are determined by a time chart used during designing the curl driving cam 327c and the cutter driving cam 331.

When the binding of the wad of paper money is completed at the binding device 300, the transportation driving motor 210 of the transportation device 400 is driven by a command from the central controlling apparatus 500. Subsequently, the transportation driving pulley 220, the plurality of transportation driven pulleys 241 to 243 and the transportation driving belt 230 are driven by the driving of the transportation driving motor. As a result, the transportation base block 250 interlocked with the transportation driving pulley 220, the plurality of transportation driven pulleys 241 to 243 and the transportation driving belt 230 returns to the initial position detected by the groove sensor 290.

Meanwhile, another operation of the paper money counting apparatus having another embodied binding device shown in FIGS. 15 and 16 will be described in accordance with the present invention. Herein, in this case, detailed description on the operation of the paper money counting apparatus with another embodied binding device will be omitted because of the identicalness to the first described paper money counting apparatus except for the operation of the binding device. Thus, only the operation of another embodied binding device will be described hereinafter.

When the wad of paper money is transported to the binding device 300 by the transporting device 200, the cam driving motor 326 of the binding means 330 rotates by a command from the central control device 500, and the rotation of the cam driving motor 326 drives the driving gear 327a, thereby further driving the transmission gear 327b connected with the driving gear 327a. Once the transmission gear 327b is driven, the curl driving cam 327c and the cutter driving cam 331 respectively connected to both ends of the axle of the transmission gear 327b start driving.

At this time, because of the driving of the curl driving cam 327c, the driving lever 327d rotates in a clockwise direction by taking one end as an axis, and as rotating, the driving lever 327d pulls the wire 328a of which one end is connected to one of the second elastic members 357 and the other end is connected to the movable base plate 351. Thus, the connected second elastic member 357 is stretched, and the movable base plate 351 moves towards the pair of roll paper guide members 315a and 316a having the space in which the wad of paper money is disposed inside.

As simultaneously as the movable base plate 351 moves, the curling rotary moving bodies 324 connected with the second elastic members 357 rotates in a clockwise direction. As a result, the first elastic members 356 connected to the bottom plate 352, which moves along with the movement of the movable base plate 351, are compressed to thereby assist the movement of the movable base plate 351 caused by the wire 328a.

As the movable base plate 351 moves, the curling bars 354 of the curling means 350 also move, thereby pressing left and right and top and bottom corners of the wad of paper money disposed inside of the space created between the pair of left and right frames 311 and 312 and the pair of roll paper guide members 315a and 316a.

Simultaneously, when the curling bars 354 of the curling means 350 move, the contact plates 355 contacted to both exterior sides of the roll paper guide members 315a and 316a do not hold the outer walls of the roll paper guide members 315a and 316a. Hence, the separation elastic member formed inside of the pair of roll paper guide members 315a and 316a separates the pair of roll paper guide members 315a and 316a in opposite direction.

As the wire 328a is driven, the second elastic members 357 move as simultaneously as the movable base plate 351 moves. The curling rotary moving bodies 324 connected with the second elastic members 357 make a clockwise rotation, and as a result, the curling contact bars 325 formed at the other end of each curling rotary moving body 324 serves a role in smoothly curling the wad of paper money by pressing a central portion of one side of the wad of paper money opposite to a side in which four points are pressed by the curling bars 354 of the curling means 350 under state that the wad of paper money is disposed inside of the space created between the pair of left and right frames 311 and 312 and the pair of roil paper guide members 315 and 316.

Under this state, the roll paper supplying motor 313 makes a reverse rotation by a command from the central control device 500 to thereby firmly bind the curled wad of paper money in the roll paper guiding passage formed inside of the space between the pair of left and right frames 311 and 312 and the pair of the roll paper guide members 315a and 316a. At this time, since the pair of roll paper guide members 315a and 316a move in left and right directions by the curling means 350, there is not interference between the roll paper 302 and the pair of roll paper guide members 315a and 316a even if the roll paper 302 departs from the roll paper guiding passage.

The wad of paper money is curled by the curling means 350 as the curl driving cam 327c drives. Also, while the curled wad of paper money is bound with the roll paper 302, the cutter driving cam 327c also simultaneously drives, resulting that the cutter assembly 332 moves forwardly to a rear side of the wad of paper money. Subsequently, the cutter assembly 322 adheres the roll paper 302 supplied to the roll paper supplying means 310 and cuts the roll paper 302 thereafter.

Herein, the moments of curling the wad of paper money, reversely supplying the roll paper 302 and adhering and cutting the roll paper 302 are determined by a time chart used during designing the curl driving cam 327c and the cutter driving cam 331.

When the binding of the wad of paper money is completed at the binding device 300, the transportation driving motor 210 of the transportation device 400 is driven by a command from the central controlling apparatus 500. Subsequently, the transportation driving pulley 220, the plurality of transportation bell metal pulleys 241 to 243 and the transportation driving belt 230 start to drive. As a result, the transportation base block 250 interlocked with the transportation driving pulley 220, the plurality of transportation bell metal pulleys 241 to 243 and the transportation driving belt 230 return to the initial position detected by the grooved transportation sensor 290.

(2) Discriminating Mode

Meanwhile, during the paper money to be counted is transported in the normal counting mode described above, the discriminating sensor unit 513 discriminate different denomination notes, counterfeit notes, front-rear side of paper money and upper-lower side of paper money (sort function) and the like from the piece of paper money to be counted.

In the discrimination operation of paper money to be transported, when the paper money such as different denomination notes, counterfeit notes and the like are discriminated, the discriminating mode is carried out.

In such discriminating mode, when the central control device 500 receives a discrimination signal defected by the discriminating sensor unit 513, the central control device 500 outputs a corresponding command to the path change driving unit and the different denomination notes transporting unit 630 (namely, idler 631, contacting roller 632 and small wings 633), to thereby the path change-driving unit and the transporting unit 630 are driven.

As the path change-driving unit drives, the path changing unit (selector) 610 rotates around the rotary shaft 611 in counterclockwise direction, as shown in FIG. 9.

Also, as the path changing unit 610 rotates in counterclockwise direction, the path changing unit 610 blocks the transporting path through which paper money to be counted is transported so that the different denomination notes is transported into the different denomination notes transporting path (the different denomination notes transporting guide unit 620), as a arrow direction shown in FIG. 8. And the different denomination notes guided to the different denomination notes transporting path are transported by the different denomination note transporting unit 630 and is discharged to the stacker 112.

In the above-described discriminating mode, when the discriminated different denomination notes are discharged outside, it allows user to stop the operation of the counting apparatus or to maintain the normal counting mode and the discriminating mode until all pieces of paper money placed on the paper money receiving unit 111 are inputted. At this time, in consideration of efficiency for the counting apparatus, it can be understood that the latter is preferable.

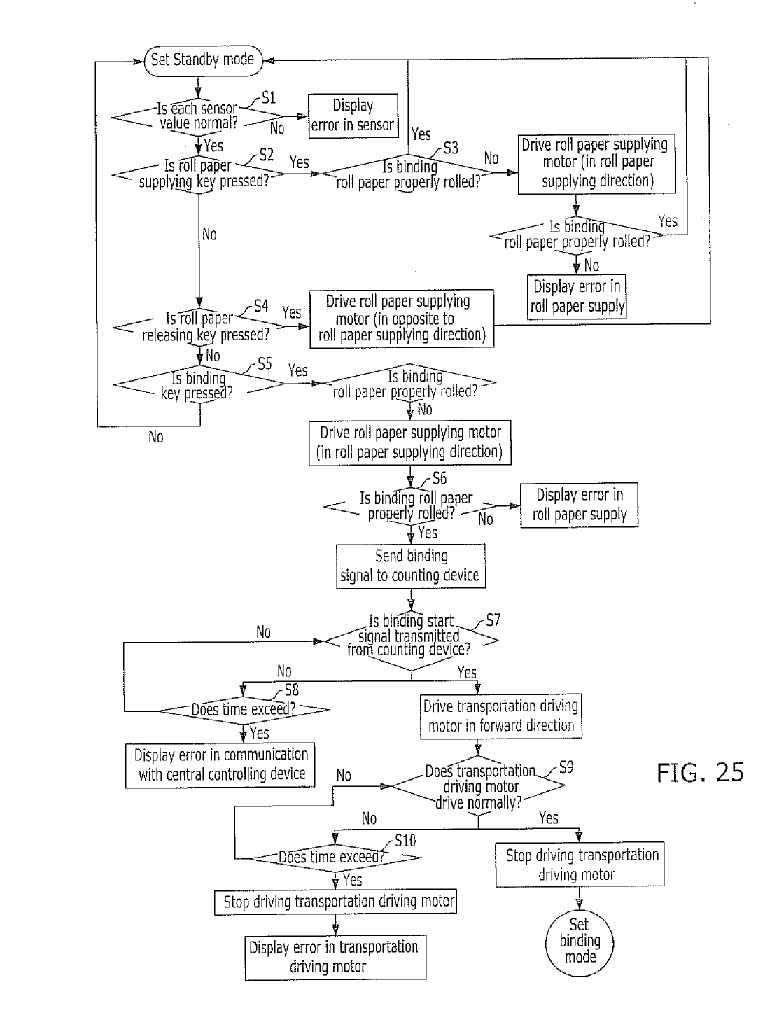

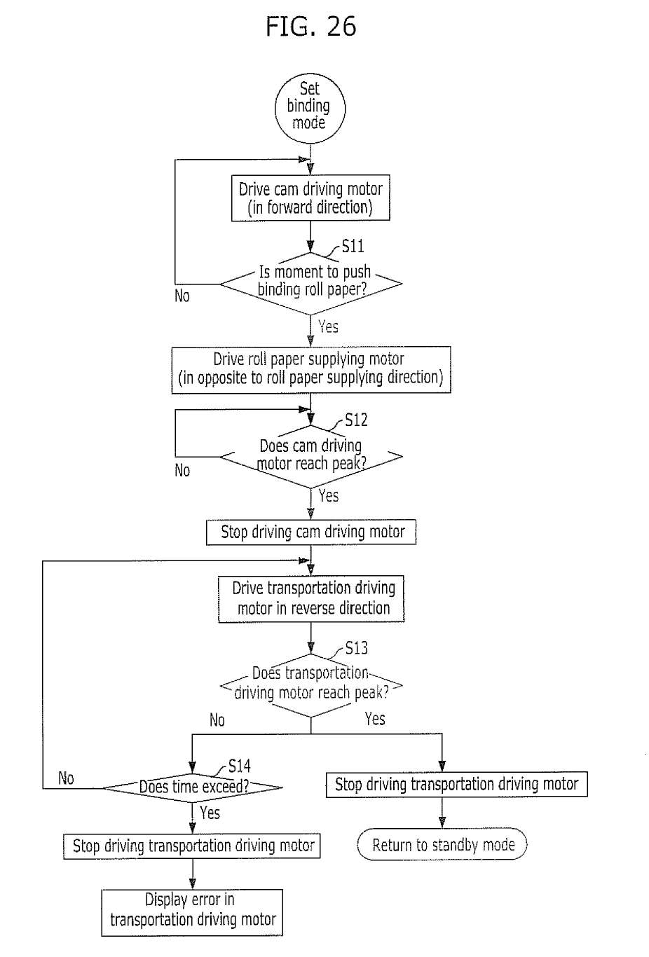

Meanwhile, With reference to FIGS. 25 and 26, the binding operation of the paper money counting apparatus provided with the auto binding-function in the counting mode will be described in accordance with the present invention. Hereinafter, the binding operation will be described in detail. Especially, FIGS. 25 and 26 are flowcharts describing the binding operation of the paper money counting apparatus provided with the auto binding-function in accordance with the present invention.

At step S1, it is determined whether each value of the sensors is normal in a standby state. If each sensor value is determined to be normal, at step S2, it is determined whether the roll paper supplying key for supplying the roll paper in an initial operation stage is pressed. If each sensor value is determined to be abnormal, a message indicating an error in the sensor appears on the display unit.

If the roll paper supplying key is pressed, at step S3, it is determined whether the roll paper for use in binding is rolled properly. If the binding roll paper is rolled, the standby state is maintained. If otherwise, the roll paper supplying motor for supplying the binding roll paper starts driving. After driving the roll paper supplying motor, it is decided again whether the binding roll paper is rolled properly by the roll paper supplying motor. If the binding roll paper is properly rolled, the standby state is maintained. If otherwise, a message indicating an error in the roll paper supply appears on the display unit.

Next, if it is decided that the roll paper supplying key is not pressed, it is accepted that the roll paper releasing key for releasing the roll paper from the binding device is pressed at step S4. The roll paper supplying motor for removing the roll paper drives in an opposite direction to the roll paper supplying direction. If it is determined that the roll paper releasing key is not pressed, the next step S5 of determining whether the binding key is pressed proceeds.

If it is accepted that the binding key is not pressed, the operation returns to the standby state. Meanwhile, if the binding key is pressed, it is checked whether the binding roll paper is properly rolled. If the binding roll paper is not properly rolled, the roll paper supplying motor for supplying the roll paper drives in a direction of supplying the roll paper.

After driving the roll paper supplying motor, it is checked whether the supplied roll paper is rolled properly at step S6. If the rolling is not properly done, the display unit shows a message indicating there is an error in the roll paper supply. If otherwise, a command signal to bind the wad of paper money is transmitted to the counting apparatus from the central control device.

At step S7, it is checked whether a signal for starting the binding operation is received from the central control device. If the above signal is received, the transportation driving motor starts to drive. If otherwise, it is determined whether time exceeds at step S8. If the time exceeds, a message indicating an error in communication with the central control device appears on the display unit. If otherwise, the operation is returned to the step S7.

After driving the transportation driving motor, it is determined whether the transportation driving motor drives normally at step S9. In case of the normal driving of the transportation driving motor, the transportation driving motor gets to stop driving to proceed with the binding mode (refer to FIG. 25). In case of the abnormal driving of the transportation driving motor, at step S10, it is decided whether time exceeds at step S10. If the time dose not exceed, the operation is returned to the step S9. If otherwise, the transportation driving motor gets to stop driving and a message indicating an error in the transportation driving motor appears on the display unit.

Afterwards, once the binding mode is carried out, the cam driving motor drives in a forward direction, and then, it is decided whether it is a moment to push the roll paper at step S11. In case of determining to push the roll paper, the roll paper supply motor drives in an opposite direction to the roll paper supplying direction. If otherwise, the cam driving motor continuously drives.

After the roll paper supplying motor drives in a reverse direction, at step S12, it is determined whether the cam driving motor reaches a peak. In case of reaching the peak, the cam driving motor gets to stop. If it is determined that the peak is not reached yet, the step S12 is continued to be carried out.

After the cam driving motor stops driving, the transportation driving motor drives in a reverse direction, and then, it is determined whether the transportation driving motor reaches a peak at step S13. If the peak is reached, the transportation driving motor gets to stop to complete the binding operation. As a result, the operation returns to the standby state. If otherwise, it is determined whether time exceeds at step S14.

At step S14, if the time does not exceed, the transportation driving motor continuously drives. If otherwise, the transportation driving motor gets to stop and then, a message indicating an error in the transportation driving motor appears on the display unit.

In accordance with the present invention, there is an advantage that the paper money counting apparatus is capable of automatically processing sequential steps of counting predetermined amounts of paper money and binding the counted wad of paper money.

In the technical scope and spirit of the invention, it is understood for those skilled in the art that the multi-pocket paper money counting apparatus provided with the auto-binding function in accordance with the present invention may operated as follows.

In the operation control method for the counting apparatus in accordance with the present invention, comprising steps: inputting paper money to be counted; defecting paper money to be counted and other paper money among paper money in the middle of transportation; and guiding paper money to be counted into a first path and other paper money into a second path based on the defected result, thereby discharging paper money and other paper money from the first path and the second path, respectively.

Herein, it is preferable that the guide step includes controlling that the one of the first path and the second path are changed and selected by a path changing unit based on the defection result, wherein the first path and the second path are disposed on a downstream side of a transportation path through which paper money are transported.

Also, the operation control method for the counting apparatus may further comprises a step of arranging a wad of paper money which are discharged from the first path in use of a binding device, before and after the wad of paper money are transported in a predetermined place or during the transportation. Herein, the operation control method for the counting apparatus may further comprise steps: transporting the wad of the discharged paper money; and binding the wad of the transported paper money.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A multi-pocket paper money counting apparatus, comprising:
a counting device configured to count predetermined amounts of paper money;
a transporting guide unit configured to be disposed inside of the counting device and forming a transporting path which includes at least a first path through which paper money to be counted is transported and a second path through which paper money except for paper money to be counted is transported;
a paper money transporting unit configured to be disposed on the transporting path for transporting paper money;
a sensor unit configured to defect the transported paper money;
a path changing device configured to be disposed on the transporting path for allowing paper money to be selectively transported into the first path or the second path;
a central control device configured to control the associated components; and
multi pockets each configured to be formed on outside of the counting device for displacing paper money discharged from the counting device.

2. The multi-pocket paper money counting apparatus according to claim 1, wherein the path changing device includes:
a rotary shaft;
a driving unit configured to drive the rotary shaft; and
a plurality of guide member configured to be integrally formed on the rotary shaft along the longitudinal direction of the rotary shaft in order to guiding paper money to the first path or the second path.

3. The multi-pocket paper money counting apparatus according to claim 2, wherein the guide members is configured to be formed into an approximately triangle shape of which a lower surface forms a first guide surface for guiding paper money to the first path when the guide members allows paper money to be transported to the first path, and a side surface adjacent to lower surface forms a second guide surface for guiding paper money except for paper money to be counted to the second path when the guide members allows paper money except for paper money to be counted to be transported to the second path.

4. A multi-pocket paper money counting apparatus, comprising: a counting device configured to count predetermined amount of paper money;
a selection discharging device configured to discriminate paper money except for paper money to be counted and to discharge the discriminated paper money outside from the counting device;
a central control device configured to control the associated components; and
multi pockets each configured to be formed on outside of the counting device for displacing at least the counted paper money and paper money except for the counted paper money both which are discharged from the counting device.

5. The multi-pocket paper money counting apparatus according to claim 4, wherein the selection discharging device includes:
a sensor unit configured to be disposed at upstream side of a paper money transportation path for defecting the transported paper money;
a path changing unit configured to be disposed at downstream side of the paper money transportation path in order to allowing paper money to be selectively transported into a path for paper money to be counted or a path for different denomination notes except for the paper money to be counted;
a driving unit configured to drive the path changing unit;
a transportation guide unit configured to form a transportation path for different denomination notes transported by the path changing unit;
a transporting unit configured to be disposed at the transportation path for different denomination notes for transporting the different denomination notes; and
a stacker configured to be formed on one of the multi pockets in order to position the different denomination notes which is guided by the transportation guide unit and is discharged outside of the counting device.

6. The multi-pocket paper money counting apparatus according to claim 5, wherein the path changing unit includes:
a rotary shaft;
a driving unit configured to drive the rotary shaft; and
a plurality of guide member configured to be integrally formed on the rotary shaft along the longitudinal direction of the rotary shaft in order to guiding paper money to the first path or the second path.

7. The multi-pocket paper money counting apparatus according to claim 6, wherein the guide members is configured to be formed into an approximately triangle shape of which a lower surface forms a first guide surface for guiding paper money to the first path when the guide members allows paper money to be transported to the first path, and a side surface adjacent to lower surface forms a second guide surface for guiding paper money except for paper money to be counted to the second path when the guide members allows paper money except for paper money to be counted to be transported to the second path.

8. The multi-pocket paper money counting apparatus according to claim 1 or 5, wherein the sensor unit is configured to a contact image sensor (CIS), a infrared sensor (IR sensor), an ultraviolet sensor (UV sensor), a magnetic sensor (MG sensor) and a color recognition sensor, in single or in combination.

9. The multi-pocket paper money counting apparatus according to claim 1 or 4, wherein the counting apparatus further comprising:
an arrangement device configured to arrange a wad of the discharged and stacked paper money.

10. The multi-pocket paper money counting apparatus according to claim 9, wherein the arrangement device includes:
an up-down arrangement device configured to be mounted on a side of the counting device in order to arrange the wad of paper money up and down; and
a front-rear arrangement configured to be mounted inside of the counting device in a place where the front-rear arrangement device faces to a rear side of the wad of paper money in order to arrange the wad of paper money backward and forward.

11. The multi-pocket paper money counting apparatus according to claim 1 or 4, wherein the counting apparatus further comprising:
a transporting device configured to transport a wad of paper money which are counted from the counting device and discharged through the first path into a predetermined place; and
a binding device configured to be integrally formed in one side of the counting device in order to bind a wad of paper money transported by the transportation device.

12. An operation control method for a multi-pocket paper money counting apparatus, comprising steps:
inputting paper money to be counted;
defecting paper money to be counted and other paper money among paper money in the middle of transportation; and
guiding paper money to be counted into a first path and other paper money into a second path based on the defected result, thereby discharging paper money and other paper money from the first path and the second path, respectively.

13. The operation control method for a multi-pocket paper money counting apparatus according to claim 12, wherein the guide step includes: controlling that the one of the first path and the second path are changed and selected by a path changing unit based on the defection result, wherein the first path and the second path are disposed on a downstream side of a transportation path through which paper money are transported.

14. The operation control method for a multi-pocket paper money counting apparatus according to claim 12, further comprising a step:
arranging a wad of paper money which are discharged from the first path in use of a binding device, before and after the wad of paper money are transported in a predetermined place or during the transportation.

15. The operation control method for a multi-pocket paper money counting apparatus according to claim 12, further comprising steps:
transporting the wad of the discharged paper money; and
binding the wad of the transported paper money.
